(19) United States
(12) Patent Application Publication
(10) Pub. No.: US 2025/0326336 A1
(43) Pub. Date: Oct. 23, 2025

(54) BASE, HOLDING MECHANISM, CROTCH BELT BUCKLE RECEIVING DEVICE, AND CHILD SAFETY SEAT

(71) Applicant: WONDERLAND SWITZERLAND AG, Steinhausen (CH)

(72) Inventors: Yingzhong CHEN, Dongguan, Guangdong (CN); Zuijan LIU, Dongguan, Guangdong (CN); Ruyi LI, Dongguan, Guangdong (CN)

(73) Assignee: WONDERLAND SWITZERLAND AG, Steinhausen (CH)

(21) Appl. No.: 18/864,360

(22) PCT Filed: May 9, 2023
(86) PCT No.: PCT/EP2023/062229

§ 371 Date: Nov. 8, 2024

(30) Foreign Application Priority Data
May 9, 2022 (CN) 202210500423.4
Oct. 28, 2022 (CN) 202211340373.4
Jan. 13, 2023 (CN) 202310076536.0

(51) Int. Cl. B60N 2/28

(52) U.S. Cl. CPC B60N 2/2827

(57) ABSTRACT

The present disclosure discloses a base, a holding mechanism, a crotch belt buckle receiving device and a child safety seat. The base is used for a child safety seat, and includes: a housing forming an appearance of the base; a base bracket accommodated in the housing; and an anchor assembly telescopically and pivotably connected to the base bracket and at least partially extending out of the housing. The holding mechanism enables a headrest to lean forward when being impacted by an external force. The crotch belt buckle receiving device is arranged in a seat portion of a seat body of the child safety seat. The child safety seat includes a seat body and a headrest. The base and the child safety seat provided by the present disclosure have good safety and convenient operation.

This application is a National Stage application of PCT/EP2023/062229, filed on May 9, 2023, which claims the benefit of Chinese Application No. 202310076536.0, filed on Jan. 13, 2023, Chinese Application No. 202211340373.4, filed on Oct. 28, 2022 and Chinese Application No. 202210500423.4, filed on May 9, 2022, all of which are incorporated herein by reference in their entirety.

### TECHNICAL FIELD

The present disclosure relates to the technical field of child safety seats, in particular to a base, a holding mechanism, a crotch belt buckle receiving device and a child safety seat.

### BACKGROUND

The child safety seat is a device specially designed for children, and a child is restrained in the safety seat during traveling. In the case of collision or sudden deceleration, the impact on the child can be reduced and a movement of the child's body can be limited, thereby reducing injuries on the child and effectively improving the riding safety of the child.

Generally, when a child sits in a vehicle, a child safety seat is installed on a vehicle seat to provide safety protection for the child during riding.

The ISOFIX (International Standards Organization FIX) connecting part of the existing child safety seat is fixed, that is, rigidly connected with the seat. When a child sits on the child safety seat, the child will generally press the child safety seat down due to his/her own weight.

Some existing child safety seats have a Harness mode of use (suitable for younger children) and a Booster mode of use (suitable for older children). In the Harness mode of use, the child is restrained through a three-directional or five-directional fastener provided by the child safety seat itself, while in the Booster mode of use, a height of the headrest of the child safety seat is properly adjusted and the child is restrained through the vehicle safety belt.

### SUMMARY

In an aspect, the present disclosure provides a base for a child safety seat. The base includes: a housing; a base bracket received in the housing; and an anchor assembly telescopically and pivotably connected to the base bracket, and at least partially extends out of the housing.

On the other hand, the present disclosure provides a base. The base includes a housing enclosing a space; a base bracket arranged in the space and forming a first sliding groove; and an anchor assembly having a pivot shaft located in the first sliding groove to form a pivot point.

According to an aspect of the present disclosure, a seat is provided. The seat includes a seat body including a backrest portion. The backrest portion includes a backrest plate; a headrest arranged on an upper part of the seat body, and including a headrest bracket and a headrest body arranged on the headrest bracket, wherein the headrest bracket is connected to the backrest plate; and a holding mechanism enabling the headrest to lean forward when being impacted by an external force.

According to another aspect of the present disclosure, a holding mechanism is provided. The holding mechanism is installed in a seat, the holding mechanism enables a headrest of the seat to lean forward when the seat is impacted by an external force, and the holding mechanism includes: a pivot shaft passing through a lower end of the backrest plate of the seat and connected with pivot holes on a seat body of the seat at both sides respectively; a fixing sheet fixed on a back side of the backrest plate and provided with a perforation; a limiting rod passing through the seat body and the perforation on the fixing sheet to connect the backrest plate, the headrest and the seat body together; and a limiting chute arranged on the seat body, wherein the limiting rod slides in the limiting chute.

According to yet another aspect of the present disclosure, a seat is provided. The seat includes a base; a seat body arranged on the base and comprising a backrest portion, wherein the backrest portion includes a backrest plate; a headrest arranged on an upper part of the seat body, and including a headrest bracket and a headrest body arranged on the headrest bracket. The seat further includes the holding mechanism as described above.

The present disclosure further provides a crotch belt buckle receiving device, arranged in a seat portion of a seat body of a child safety seat and including a receiving slot for receiving a crotch belt buckle, and a trigger arranged in the receiving slot and being movable between an extended position and a retracted position relative to an inner side wall of the receiving slot, and the trigger being linked with a limiting device through a linkage, so that when the crotch belt buckle is received in the receiving slot, the trigger is in the retracted position, and the limiting device limits a lower limit stroke of a headrest of the child safety seat relative to a backrest of the seat body; when the crotch belt buckle is not received in the receiving slot, the trigger is in the extended position, and the limiting device limits an upper limit stroke of the headrest relative to the backrest.

The present disclosure provides a child safety seat, including a seat body and a headrest, wherein a seat portion of the seat body is provided with the crotch belt buckle receiving device.

### BRIEF DESCRIPTION OF THE DRAWINGS

Various objects, features and advantages of the present disclosure will become more apparent by considering the following detailed description of preferred embodiments of the present disclosure in conjunction with the accompanying drawings. The drawings are only exemplary illustrations of the present disclosure and are not necessarily drawn to scale. In the drawings, the same reference numbers refer to the same or similar parts throughout. In the drawings:

FIG. 1 is a side view of a child safety seat of the present disclosure, in which an anchor assembly is in a horizontal state and a retracted position;

FIG. 2 is a side view of the child safety seat of the present disclosure, in which the anchor assembly is in the horizontal state and an extended position;

FIG. 3 is a side view of the child safety seat of the present disclosure, in which the anchor assembly is in a tilted state and an extended position;

FIG. 4 is a perspective view of a base bracket of the present disclosure;

FIG. 5 is an enlarged view of area A of FIG. 4;

FIG. 6 is an enlarged view of area B of FIG. 4;

FIG. 7 is a perspective view of a limiting press block of the present disclosure;

FIG. 8 is another perspective view of the limiting press block of the present disclosure;

FIG. 9 is a perspective view of the base bracket of the present disclosure, in which the limiting press block is not shown and the anchor assembly is in the horizontal state and then extended position;

FIG. 10 is a perspective view of the base bracket of the present disclosure, in which the limiting press block is not shown and the anchor assembly is in the tilted state and the extended position;

FIG. 11 is a perspective view of the base bracket of the present disclosure, in which the anchor assembly is locked;

FIG. 12 is a perspective view of the base bracket of the present disclosure, in which the anchor assembly is unlocked;

FIG. 13 is a schematic front view showing a child safety seat according to another embodiment of the present disclosure;

FIG. 14 is a schematic rear view showing the child safety seat according to another embodiment of the present disclosure;

FIG. 15 is a schematic view showing a holding mechanism of the child safety seat according to another embodiment of the present disclosure;

FIG. 16 is a rear schematic view showing a headrest bracket of the child safety seat according to another embodiment of the present disclosure;

FIG. 17 is a schematic side view showing the headrest bracket of the child safety seat according to another embodiment of the present disclosure;

FIG. 18 is a schematic view showing a leaning-forward movement of a headrest of the child safety seat according to another embodiment of the present disclosure;

FIG. 19 is a schematic front view showing the child safety seat according to yet another embodiment of the present disclosure;

FIG. 20 is a schematic rear view showing the child safety seat according to yet another embodiment of the present disclosure;

FIG. 21 is a schematic view showing a holding mechanism according to yet another embodiment of the present disclosure;

FIG. 22 is a schematic view showing the holding mechanism in a first state according to yet another embodiment of the present disclosure;

FIG. 23 is a schematic view showing the holding mechanism in a second state according to yet another embodiment of the present disclosure;

FIG. 24 is a perspective view of a child safety seat according to some embodiment of the present disclosure, in which a crotch belt buckle receiving device is arranged at a position of a seat portion close to a backrest;

FIG. 25 is a perspective view showing that a crotch belt buckle of the child safety seat according to some embodiment of the present disclosure is received in a receiving slot of the crotch belt buckle receiving device, in which a receiving cover for covering the receiving slot is removed to show an interior of the receiving slot;

FIG. 26 is a schematic perspective view of the child safety seat according to some embodiment of the present disclosure, in which the receiving cover and the crotch belt buckle are removed to show the receiving slot;

FIG. 27 is an enlarged view of an area A selected in FIG. 25;

FIG. 28 shows a schematic view of a bottom side of the child safety seat according to some embodiment of the present disclosure;

FIG. 29 is an enlarged view of an area B selected in FIG. 28, specifically showing a trigger, a linkage and a limiting device of the child safety seat according to some embodiment of the present disclosure;

FIG. 30 shows a schematic bottom view of the child safety seat according to some embodiment of the present disclosure, and shows a partial exploded view;

FIG. 31 is an enlarged view of an area C selected in FIG. 30, specifically showing the trigger of the child safety seat according to some embodiment of the present disclosure;

FIG. 32 shows a schematic bottom view of the child safety seat according to some embodiment of the present disclosure in view of another angle;

FIG. 33 is an enlarged view of an area D selected in FIG. 32, specifically showing the limiting device of the child safety seat according to some embodiment of the present disclosure;

FIG. 34 shows a schematic side view of the child safety seat according to some embodiment of the present disclosure in a Harness use mode;

FIG. 35 is an enlarged view of an area E selected in FIG. 34;

FIG. 36 shows a schematic side view of the child safety seat according to some embodiment of the present disclosure in a Booster use mode; and

FIG. 37 is an enlarged view of an area F selected in FIG. 36.

List of Reference numbers:

| | |
|---|---|
| 100 | Child Safety Seat |
| 1 | Base |
| 10 | Housing |
| 20 | Base Bracket |
| 201 | Sheet |
| 210 | First Sliding Groove |
| 230 | Adjusting Sliding Slot |
| 240 | Rotary Limiting Groove |
| 250 | Base Bracket Connecting Rod |
| 260 | Connecting Hole |
| 280 | Limiting Groove |
| 30 | Anchor Assembly |
| 310 | Pivot Shaft |
| 320 | Sliding Part |
| 330 | Connecting Part |
| 340 | Reset Element |
| 350 | Reinforcement Element |
| 351 | Locking Hole |
| 360 | Connecting Rod |
| 370 | Connecting rod |
| 40 | Limiting Press Block |
| 410 | Pivot Hole |
| 420 | Second Sliding Groove |
| 430 | Limiting Hole |
| 50 | Telescopic Adjusting Assembly |
| 510 | Telescopic Adjusting Handle |
| 511 | Recess |
| 520 | Linkage Arm |
| 521 | Pivot Shaft |
| 530 | Locking Pin |
| 2 | Seat Body |
| 1S | Child safety seat |
| 10S | Headrest |
| 12S | Headrest Bracket |
| 14S | Headrest Body |
| 141S | Backrest |
| 142S | Side Wing |
| 16S | Guider |
| 20S | Seat Body |
| 22S | Backrest portion |
| 23S | Backrest Plate |
| 24S | Seat portion |
| 26S | Pivot Hole |
| 28S | Limiting Ring |
| 30S | Base |
| 40S | Holding Mechanism |
| 431S | Limiting Block |
| 42S | Pivot Shaft |
| 44S | Fixing Sheet |
| 441S | Perforation |
| 46S | Limiting Rod |
| 461S | Inserting Hole |
| 48S | Limiting Chute |
| 49S | Elastic Element |
| 100T | safety seat |
| 110T | seat body |
| 111T | crotch belt buckle receiving device |
| 111aT | limiting column |
| 111bT | opening |
| 111cT | notch |
| 111dT | elastic finger |
| 111eT | receiving cover |
| 111fT | receiving slot |
| 111gT | receiving cover hinged shaft |
| 112T | trigger |
| 112aT | first spring |
| 112bT | limiting screw |
| 112cT | sliding slot |
| 112dT | fixing column |
| 112eT | trigger end |
| 113T | linkage |
| 114T | hook |
| 115T | hinged hole |
| 116T | fixing boss |
| 120T | crotch belt buckle |
| 130T | headrest |
| 140T | headrest bracket |
| 150T | limiting device |
| 151T | elastic catch |
| 152T | limiting pin |
| 153T | upper limiting step |
| 154T | lower limiting step |
| 155T | driving member |
| 155aT | driving chute |
| 155bT | second spring |
| 155cT | fixing hook |
| 155dT | limiting slot |
| 155eT | fixing slot |
| 156T | fixing cover |
| 156aT | fixing lug |
| 157T | pin |
| 157bT | limiting hole |
| 160T | shoulder belt perforation |
| 161T | shoulder belt |
| 162T | shoulder belt buckle |
| 170T | locking member |
| 171T | adjusting belt |
| 180T | seat portion |
| 190T | backrest |

### DETAILED DESCRIPTION

In order to explain the whole concept of the present disclosure more clearly, the following detailed description will be made by way of example with reference to the attached drawings of the specification.

It should be noted that in the following description, many specific details are set forth in order to fully understand the present disclosure. However, the present disclosure can be implemented in other ways different from those described here. Therefore, the protection scope of the present disclosure is not limited by the specific embodiments disclosed below.

In addition, in the description of the present disclosure, it should be understood that the terms “center”, “up”, “down”, “front”, “back”, “left”, “right”, “vertical”, “horizontal”, “top”, “bottom”, “inside”, “outside”, “axial”, “radial”, “circumferential”, etc. indicate the orientation or positional relationship based on the orientation or positional relationship shown in the drawings, which are only for the convenience of describing the present disclosure and simplifying the description, rather than indicating or implying that the indicated device or component must have a specific orientation, or must be constructed and operated in a specific orientation, and therefore should not be construed as a limitation on the present disclosure.

In the present disclosure, unless otherwise specified and limited, the terms “installed”, “connected”, “coupled” and “fixed” should be understood broadly, for example, may be fixed, detachable or integrated; or may be directly connected or indirectly connected through an intermediate medium, and may be in an internal communication of two components or an interaction between two components. However, direct connection means that two connected subjects do not build a connection relationship through any transitional structure, but only form an integrated part through a connection structure. For those of ordinary skill in the art, the specific meanings of the above terms in the present disclosure can be understood according to specific situations.

In the present disclosure, unless otherwise specified and limited, a first feature “on” or “under” a second feature may be in direct contact between the first and second features, or in indirect contact between the first and second features through an intermediate medium. In the description of this specification, the description referring to the terms “an embodiment”, “some embodiments”, “example”, “specific example” or “some examples” means that the specific features, structures, materials or characteristics described in connection with the embodiment or example are included in at least one embodiment or example of the present disclosure. In this specification, the schematic expressions of the above terms do not necessarily refer to the same embodiment or example. Furthermore, the specific features, structures, materials or characteristics described may be combined in any one or more embodiments or examples in a suitable manner.

The present disclosure provides a child safety seat, which may be installed on a vehicle seat for infants or children to sit and ensure the safety of the occupants. The present disclosure also provides a base which acts as a part of the child safety seat. For the “Booster” mode of use, a vehicle safety belt is used to pass through a guider on a headrest of the child safety seat, then pass by the child's chest and be fixed on the vehicle seat, so that in such a mode of use, the vehicle safety belt will apply a pulling force on the headrest when the vehicle is impacted.

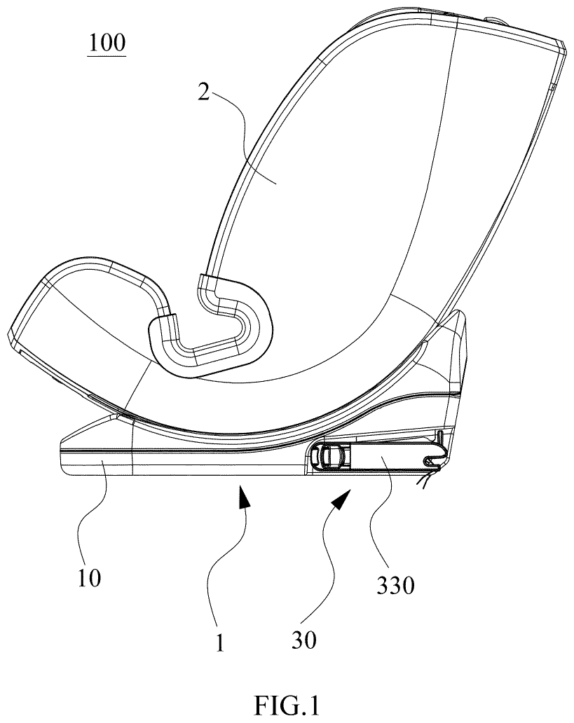

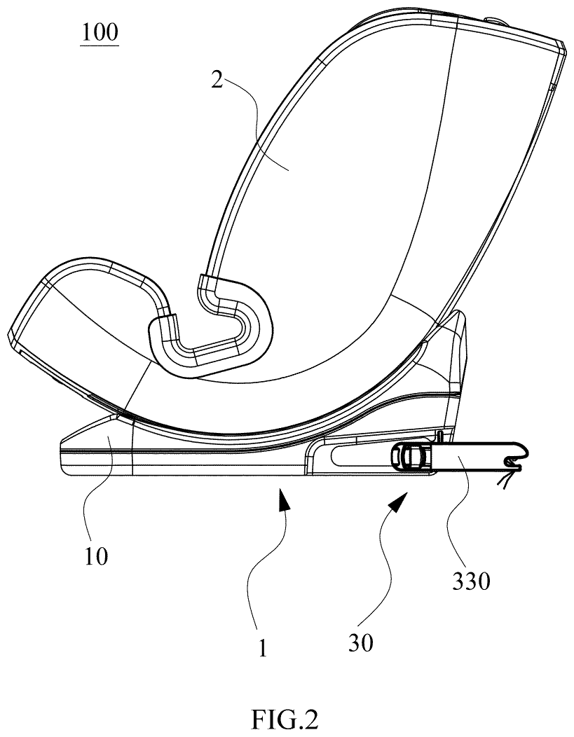

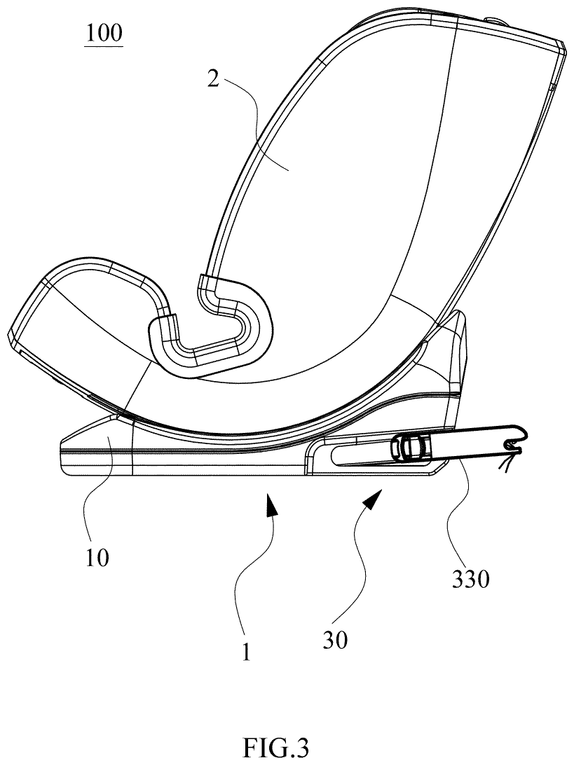

FIG. 1 is a side view of a child safety seat 100 of the present disclosure, in which an anchor assembly 30 is in a horizontal state and a retracted position; FIG. 2 is a side view of the child safety seat 100 of the present disclosure, in which the anchor assembly 30 is in the horizontal state and an extended position; and FIG. 3 is a side view of the child safety seat 100 of the present disclosure, in which the anchor assembly 30 is in a tilted state and the extended position.

Referring to FIGS. 1-3, the child safety seat 100 of the present disclosure includes a base 1 and a seat body 2 located above the base 1. The seat body 2 may have various types, such as a seat suitable for older children and a basket suitable for younger babies, etc. The seat body 2 may slide and/or rotate relative to the base 1 to adjust a posture of the seat body 2.

The base 1 includes a housing 10 and a base bracket 20. The housing 10 forms an appearance of the base 1. The housing 10 forms a cavity to enclose a space inside the housing 10. The base bracket 20 is received in the housing 10 in the space to provide a structural strength of the base 1. The base bracket 20 has an anchor assembly 30. The anchor assembly 30 is telescopically and pivotably connected to the base bracket 20 and at least partially extends out of the housing 10. Specifically, the anchor assembly 30 extends backward (i.e., towards the right in FIGS. 1-3) out of the housing 10.

A bottom surface of the housing 10 is substantially flat. The anchor assembly 30 has a horizontal state (as shown in FIGS. 1 and 2) and a tilted state (as shown in FIG. 3). In the horizontal state, the anchor assembly 30 is parallel to the bottom surface of the housing 10. In the tilted state, the anchor assembly 30 forms an angle with the bottom surface of the housing 10. Alternatively, in the horizontal state, the anchor assembly 30 forms an angle with the bottom surface of the housing 10, while in the tilted state, the anchor assembly 30 forms an angle with the bottom surface of the housing 10 that is larger than that in the horizontal state.

The anchor assembly 30 has an extended position (as shown in FIGS. 2 and 3) and a retracted position (as shown in FIG. 1). The anchor assembly 30 extends more out of the housing 10 in the extended position than in the retracted position with respect to the base 1.

It should be noted that the horizontal state and the tilted state are independent from the extended position and the retracted position. That is, for example, the anchor assembly 30 may be in the tilted state and the extended position at the same time, and the tilted state may be achieved when the anchor assembly is at any position (e.g., the extended position and the retracted position).

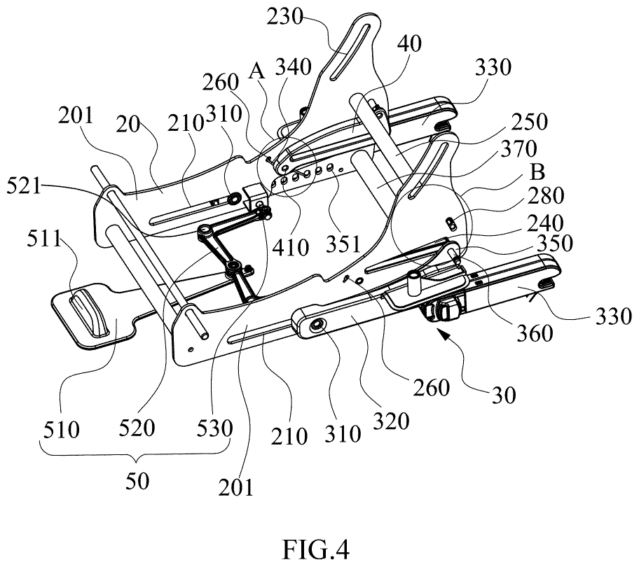

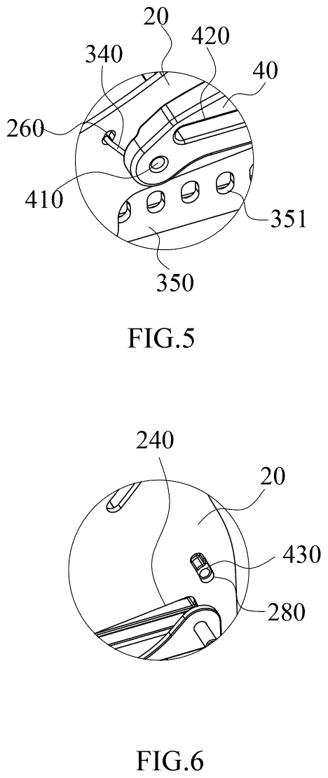

FIG. 4 is a perspective view of the base bracket 20 of the present disclosure, FIG. 5 is an enlarged view of area a of FIG. 4, and FIG. 6 is an enlarged view of area b of FIG. 4.

Referring to FIGS. 4-6, the base bracket 20 includes two sheets 201 that are symmetrical with each other. A base bracket connecting rod 250 is formed between the two sheets 201, so that a fixed distance is maintained between the two sheets 201. One or more base bracket connecting rod 250 may be provided. The base bracket 20 may also have other structures, and the present disclosure is not limited thereto.

The base bracket 20 includes a first sliding groove 210, an adjusting sliding slot 230, a rotary limiting groove 240, a base bracket connecting rod 250, a connecting hole 260 and a limiting groove 280. In the case that the base bracket 20 includes two sheets 201, each of the sheets 201 includes a first sliding groove 210, an adjusting sliding slot 230, a rotary limiting groove 240, a connecting hole 260 and a limiting groove 280.

The anchor assembly 30 includes a pivot shaft 310, a sliding part 320 and a connecting part 330. The pivot shaft 310 is located at one end of the sliding part 320, and the connecting part 330 is fixedly connected to the other end of the sliding part 320. The anchor assembly 30 as a whole rotates about the pivot shaft 310. The connecting part 330 is configured to be anchored to a fixing rod of the vehicle seat, thereby fixing the child safety seat 100 to the vehicle seat. The connecting part 330 may be an ISOFIX fixing element. Alternatively, the connecting part 330 may be any of other types of fixing elements. The sliding part 320 is fixedly connected with a reinforcement element 350 to enhance the strength of the anchor assembly 30. The reinforcement element 350 is formed as a sheet and is formed of iron. Alternatively, the reinforcement element 350 may be formed of another material, such as steel and aluminum, and the present disclosure is not limited thereto. Other parts of the anchor assembly 30, such as the sliding part 320, is formed as plastic, for example, and the plastic part at least partially covers the reinforcement element 350. A part of the reinforcement element 350 extends vertically upward to be formed as a lug. “Vertically upward” can refer to in a direction vertically upward as shown in FIGS. 1-3. Optionally, the sliding part 320 may not include the reinforcement element 350.

The first sliding groove 210 is formed as a horizontal elongated groove. The pivot shaft 310 is slidably arranged in the first sliding groove 210. In this way, the pivot shaft 310 is allowed to rotate in the first sliding groove 210 and slide along the first sliding groove 210.

The adjusting sliding slot 230 is formed at the rear side of the first sliding groove 210 (the right side in FIGS. 1-3) on the sheet 201, and a position thereof is higher than that of the first sliding groove 210. The adjusting sliding slot 230 is formed as an inclined elongated shape or an arc shape. A part of the seat body 2 is located in the adjusting sliding slot 230, so that the seat body 2 is allowed to slide along the adjusting sliding slot 230 with respect to the base 1, thereby adjusting a position and/or an angle of the seat body 2 with respect to the base 1.

The rotary limiting groove 240 is formed in a front-back direction (i.e., a left-right direction in FIGS. 1-3). A width of the rotary limiting groove 240 in a vertical direction is gradually widened from front to back, and the entire rotary limiting groove 240 is triangular. Alternatively, the entire rotary limiting groove 240 is trapezoidal, or the width of the rotary limiting groove 240 in the vertical direction is provided to be constant. The limiting press block 40 is pivotably connected to the base bracket 20. The limiting press block 40 is arranged at a side of the base bracket 20 opposite to the anchor assembly 30. For example, the limiting press block 40 is arranged between two sheets 201 of the base bracket 20 (i.e., inner side), and the two anchor assemblies 30 are arranged at an outer side of the two sheets 201 of the base bracket 20. Both the limiting press block 40 and the anchor assembly 30 may abut against the base bracket 20. A connecting rod 370 is formed between the two anchor assemblies 30 to keep movements of the two anchor assemblies 30 synchronized.

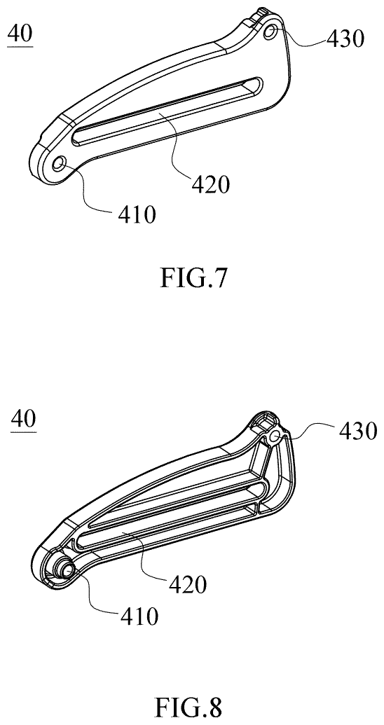

FIG. 7 is a perspective view of the limiting press block 40 of the present disclosure, and FIG. 8 is another perspective view of the limiting press block 40 of the present disclosure.

Referring to FIGS. 7 and 8 and 4-6, the limiting press block 40 includes a pivot hole 410, a second sliding groove 420 and a limiting hole 430. The second sliding groove 420 is formed as an elongated shape.

The pivot hole 410 is connected to the base bracket 20 via a pivot shaft (not shown), so that the limiting press block 40 is configured to pivot about the pivot hole 410. The reset element 340 is connected to the base bracket 20 and the limiting press block 40 to maintain a reset force applied to the limiting press block 40. The reset element 340 is a torsion spring or other elements capable of providing a restoring force. In the embodiment where the reset element 340 is a torsion spring, one arm of the torsion spring is connected to the connecting hole 260, the other arm of the torsion spring is connected to the limiting press block 40, and a body of the torsion spring is sleeved on the pivot shaft passing through the pivot hole 410.

The limiting hole 430 is connected with the limiting groove 280 of the base bracket 20 by a rivet, a pin or a screw, so that the limiting groove 280 limits a pivoting angle of the limiting press block 40.

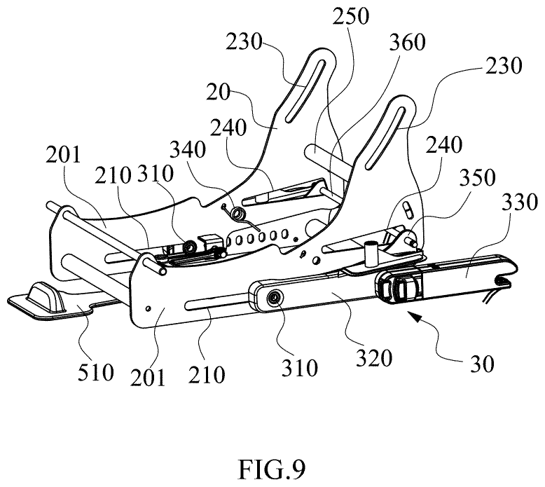

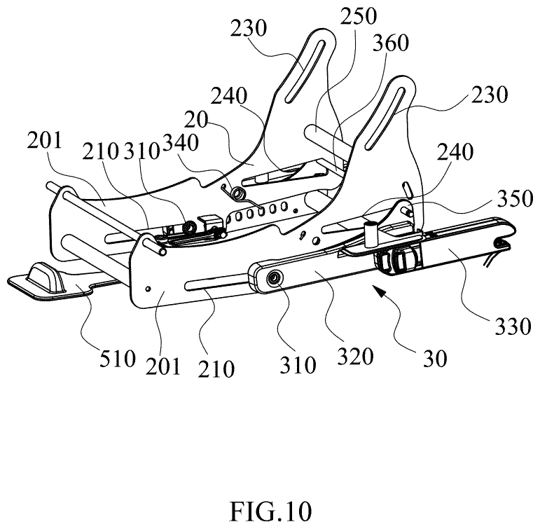

The anchor assembly 30 further includes a connecting rod 360. The connecting rod 360 perpendicularly extends from the reinforcement element 350 and passes through the second sliding groove 420 and the rotary limiting groove 240. In the embodiment shown in FIG. 4, each of two anchor assemblies 30 has a connecting rod 360. In another embodiment (as shown in FIGS. 9 and 10), two anchor assemblies 30 share a connecting rod 360. That is, the connecting rod 360 connects the two reinforcing members 350 and passes through the two second sliding grooves 420 and the two rotary limiting grooves 240.

FIG. 9 is a perspective view of the base bracket 20 of the present disclosure, in which the limiting press 40 is not shown and the anchor assembly 30 is in the horizontal state and the extended position, and FIG. 10 is a perspective view of the base bracket 20 of the present disclosure, in which the limiting press block 40 is not shown and the anchor assembly 30 is in the tilted state and the extended position.

Referring to FIGS. 9, 10 and 4, since the anchor assembly 30 is configured to pivot about the pivot shaft 310, when the child safety seat 100 is installed on the vehicle seat and a child has been seated on the child safety seat 100, the child safety seat 100 will move downward due to the gravity of the child, causing the anchor assembly 30 to pivot counterclockwise (with reference to FIGS. 1-3) about the pivot shaft 310. At the same time, the sliding part 320 drives the connecting rod 360 to move together, and then drives the limiting press block 40 to pivot about the pivot hole 410 against the reset force of the reset element 340. When the connecting rod 360 moves upward to abut against an upper side of the rotary limiting groove 240, the anchor assembly 30 cannot pivot further. In this way, the anchor assembly 30 completes the change from the horizontal state to the tilted state.

When the child moves away from the child safety seat 100, the reset force of the reset element 340 drives the limiting press block 40 to pivot clockwise about the pivot axis of the pivot hole 410, and the second sliding groove 420 transmits the clockwise pivoting to the connecting rod 360, and then causes the anchor assembly 30 to pivot clockwise about the pivot shaft 310. When the connecting rod 360 moves downward to abut against a lower side of the rotary limiting groove 240, the anchor assembly 30 cannot pivot further. In this way, the anchor assembly 30 is returned from the tilted state to the horizontal state.

The anchor assembly 30 further includes a plurality of locking holes 351. The plurality of locking holes 351 are formed at an inner side of the sliding part 320, specifically, for example, at an inner side of the reinforcement element 350. Each of sliding parts 320 is provided with a row of locking holes 351 spaced apart from each other. The locking hole 351 is circular or elongated.

With continued reference to FIG. 4, the base 1 further includes a telescopic adjusting assembly 50. The telescopic adjusting assembly 50 includes a telescopic adjusting handle 510, a linkage arm 520 and a locking pin 530. The telescopic adjusting handle 510 is connected to the locking pin 530 via the linkage arm 520, so that the movement of the telescopic adjusting handle 510 enables the locking pin 530 to disengage from the locking hole 351. When the child safety seat 100 is used, the locking pin 530 is inserted into or engaged with one of the locking holes 351.

The telescopic adjusting handle 510 is at least partially exposed out of the housing 10. Specifically, the telescopic adjusting handle 510 extends from a bottom of the housing 10. The telescopic adjusting handle 510 is formed with a recess 511 (recessed upward into the interior of the housing 10 when viewed from the bottom) to facilitate manual actuation of the telescopic adjusting handle 510 from the bottom of the housing 10, for example. The recess 511 is recessed into a space formed by the housing 10.

The linkage arm 520 is formed as an “L” shape. The linkage arm 520 is pivotably arranged in the housing 10. The pivot shaft 521 of the linkage arm 520 is formed at a bend part of the “L” shape. As an alternative embodiment, the pivot shaft 521 of the linkage arm 520 is formed at other position of the linkage arm 520, and the present disclosure is not limited thereto. In the embodiment where the base bracket 20 includes two sheets 201, the telescopic adjusting assembly 50 includes two linkage arms 520 and two locking pins 530. The two arms of the “L”-shaped linkage arm 520 are perpendicular to each other or at other angles.

One end of the telescopic adjusting handle 510 away from the recess 511 is pivotably connected to one end of the linkage arm 520, and the other end of the linkage arm 520 is connected with the locking pin 530. A reset element (not shown) acts on the telescopic adjusting assembly 50, so that the locking pin 530 tends to move in a direction for inserting into or engaging with the locking hole 351. A structure for guiding the movement of the locking pin 530 is formed on the base bracket 20 to ensure that the locking pin 530 is accurately inserted into the locking hole 351. In the embodiment with two linkage arms 520 and two locking pins 530, since the ends of the two linkage arms 520 are connected to the same location of the telescopic adjusting handle 510, both linkage arms 520 move synchronously, and both locking pins 530 move synchronously.

In the present disclosure of the base 20, a length of the anchor assembly 30 extending out of the base 20 is adjustable. That is, the anchor assembly 30 is configured to be fixed in the extended position, the retracted position and any of a plurality of positions therebetween.

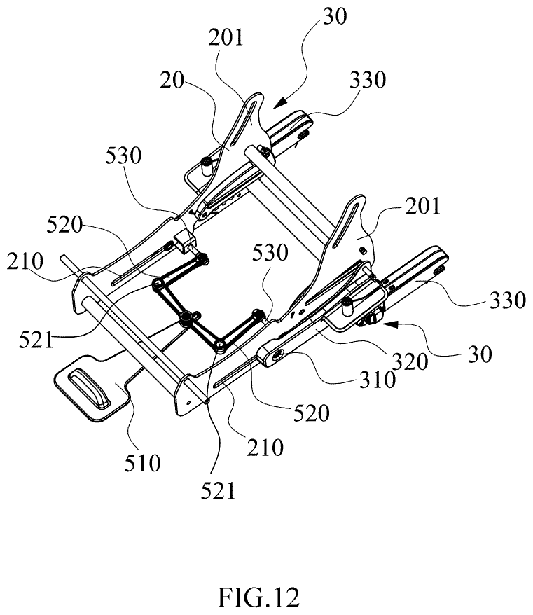

Specifically, when the telescopic adjusting handle 510 is pulled forward (to the left in FIGS. 1-3), the telescopic adjusting handle 510 drives the linkage arm 520 to rotate about its pivot axis, and the rotation of the linkage arm 520 further drives the locking pin 530 to disengage from the locking hole 351 (as shown in FIG. 12).

At this time, since the pivot shaft 310 is slidable in the first sliding groove 210, when the telescopic adjusting handle 510 is pulled, the anchor assembly 30 may perform translational movement thereof, i.e., extending from and retracting into the housing 10. Since each of the rotary limiting groove 240 and the second sliding groove 420 has a certain length along the front-back direction of the child safety seat 100, that is, a length of each of the rotary limiting groove 240 and the second sliding groove 420 is at least greater than or equal to a length of the first sliding groove 210, neither the rotary limiting groove 240 nor the limiting press block 40 will hinder the anchor assembly 30 from moving to the extended position and the retracted position.

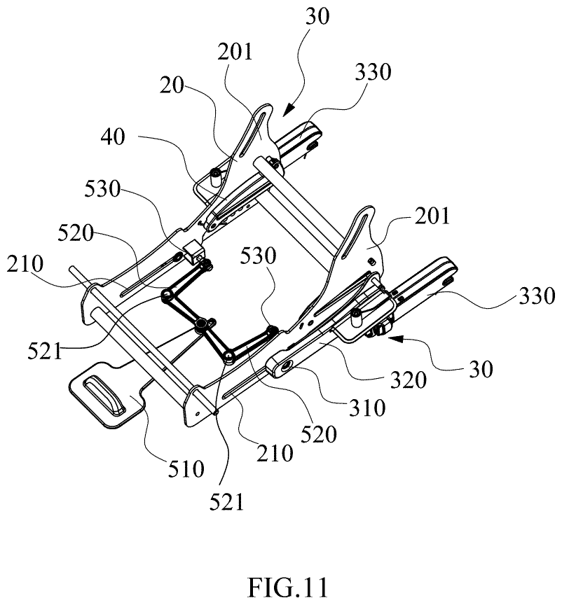

When the telescopic adjusting handle 510 is released, the linkage arm 520 rotates about its pivot axis in a direction opposite to that as mentioned above due to the restoring force of the reset element, thereby driving the telescopic adjusting handle 510 to an unactuated position and inserting or engaging the locking pin 530 into the corresponding locking hole 351 (as shown in FIG. 11).

In the present disclosure, since the sliding part 320 has a certain length, and the pivot shaft 310 is arranged at an end away from the connecting part 330, the pivot point is away from an anchor point of the connecting part 330, so that an arm of force of the anchor assembly 30 is longer and can bear greater force when it is impacted. The present disclosure provides a base and a child safety seat, which can avoid the problem of that: a head of a child is easy to hit a roof of a vehicle and is thus easily injured when the child safety seat is impacted.

The following description takes a child safety seat as an example of the seat, however, the seat according to the present disclosure is not limited to the child safety seat, and can also be a highchair, an ordinary child seat and the like.

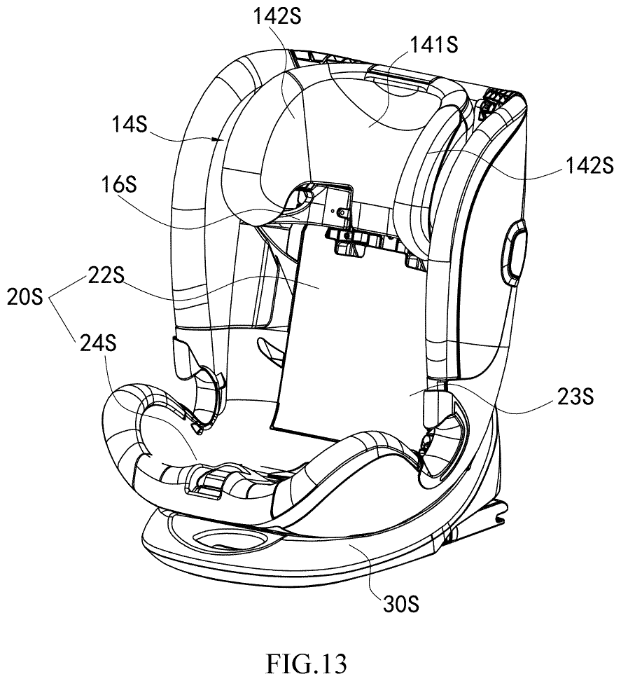

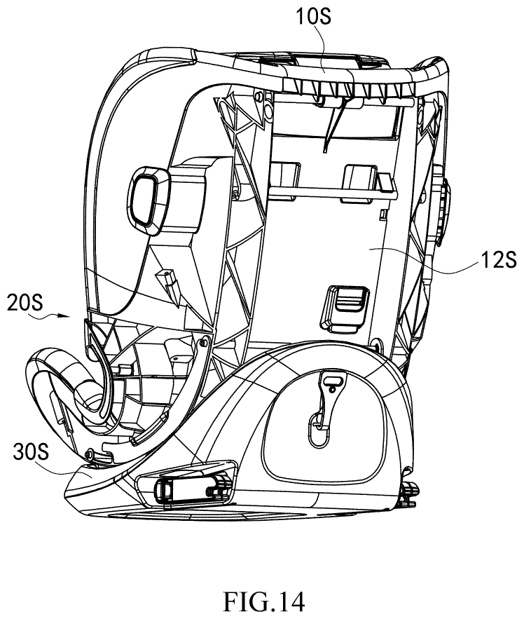

Hereinafter, description will be made with reference to FIGS. 13 and 14, wherein FIG. 13 is a schematic front view showing the seat according to another embodiment of the present disclosure, and FIG. 14 is a schematic rear view showing the seat according to another embodiment of the present disclosure. As shown in FIGS. 13 and 14, the child safety seat 1S according to the present disclosure includes a base 30S, a seat body 20S, and a headrest 10S. The base 30S is configured to be fixedly arranged on a vehicle seat. The seat body 20S is arranged on the base 30S and includes a backrest portion 22S and a seat portion 24S. The backrest portion 22S includes a backrest plate 23S with rigidity to provide support strength for the backrest portion 22S, and the backrest plate 23S of some embodiment is fixed on the seat body 20S. The headrest 10S is arranged on an upper part of the seat body 20S and includes a headrest bracket 12S, a headrest body 14S arranged on the headrest bracket 12S, and a guider 16S The headrest 10S is configured to slide up and down with respect to the backrest portion 22S to adjust a position of the headrest 10S, thereby meeting the riding requirements of children with different heights. The headrest body 14S includes a backrest 141S and two side wings 142S, and the guider 16S is arranged on a lower end of the side wings 142S.

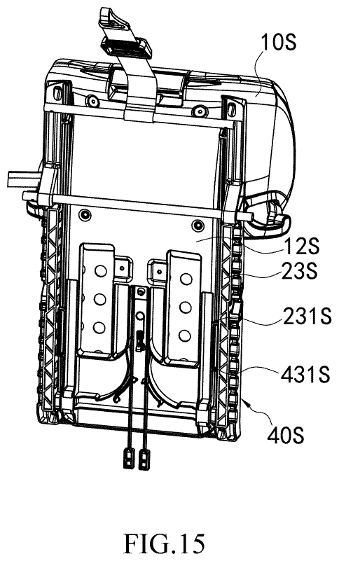

Referring to FIG. 15 of the present disclosure, FIG. 15 is a schematic view showing a holding mechanism of the seat according to another embodiment of the present disclosure. The child safety seat 1S according to the present disclosure further includes a holding mechanism 40S, which can increase the deformability of the headrest 10S when it is impacted by an external force, so that the headrest 10S may move forward to better follow the neck of the child to always provide support and to ensure that a distance between the neck and the vehicle safety belt remains unchanged.

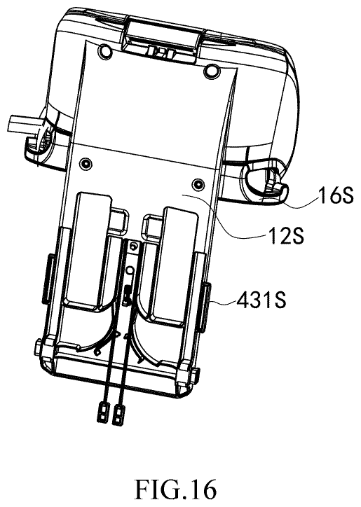

With reference to FIG. 16, FIG. 16 is a schematic rear view showing the headrest bracket of the seat according to another embodiment of the present disclosure, the headrest 10S is configured to move up and down with respect to the backrest portion 22S to adjust the position of the headrest 10S, the holding mechanism 40S restricts the displacement of the headrest 10S in the front-back direction and the left-right direction, and a limit fixing point between the headrest bracket 12S and the backrest plate 23S is arranged below a middle portion of the headrest bracket 12S in a longitudinal direction. The holding mechanism 40S according to another embodiment includes two limiting blocks 431S arranged on two sides of the headrest bracket 12S. In order to improve the deformability of the headrest 10S, the limiting block 431S is arranged below the middle portion of the headrest bracket 12S in the longitudinal direction so that a vertical distance between an upper end of the limiting block 431S and the headrest body 14S is increased. Two guide rails 231S are provided on the two sides of the backrest plate 23S corresponding to the limiting blocks 431S respectively, and the limiting blocks 431S are configured to slide up and down in the guide rails 231S, so that the headrest 10S moves up and down along with the headrest bracket 12S to meet the use requirements of children with different heights. The sliding fit of the limiting block 431S in the guide rail 231S only limits the displacement of the headrest 10S in the front-back direction and left-right direction, however, it does not limit the sliding of the headrest 10S in an up-down direction.

According to a variation of this embodiment, the holding mechanism 40S includes two guide rails arranged on two sides of the headrest bracket 12S; and two limiting blocks are provided on two sides of the backrest plate 23S corresponding to the guide rails respectively. Similarly, in order to increase the deformability of the headrest 10S, the guide rails on the headrest bracket 12S are provided below the middle portion of the headrest bracket 12S in the longitudinal direction. The sliding fit between the limiting block and the guide rail enables the headrest 10S to move up and down along with the headrest bracket 12S, and limits the displacement of the headrest 10S in the front-back direction and left-right direction.

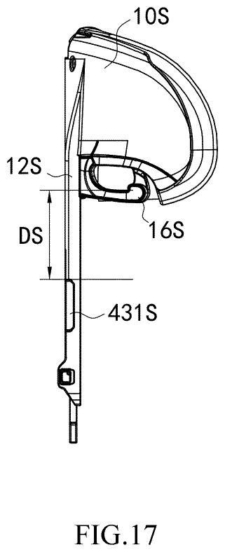

Each of left and right sides of the headrest 10S is provided with a guider 16S, so that the child safety seat 1S is installed on any of the left and right sides of the back seat of the vehicle, which is convenient for installation and use. In the booster mode of use, the vehicle safety belt passes through the guide 16S, then passes by the chest of the child, and is fixed to the seat of the vehicle. In some embodiment according to the present disclosure, as shown in detail in FIG. 17, which is a schematic side view showing the headrest bracket of the seat according to another embodiment of the present disclosure, a vertical distance between a lower edge of an inner opening of the guider 16S and an upper end of the limiting block 431S is not less than 110 mm.

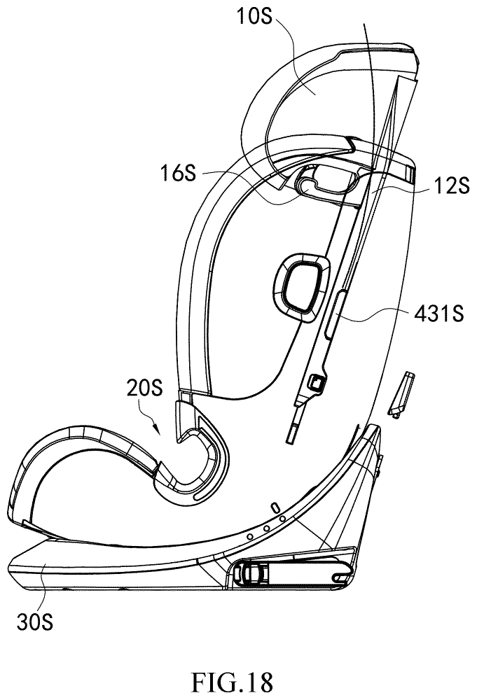

Based on the holding mechanism 40S of this embodiment, the limiting block 431S is arranged below the middle portion of the headrest bracket 12S in the longitudinal direction. For example, in some embodiment, the left and right sides of the headrest 10S are provided with two guiders 16S, and the vertical distance between the lower edge of the inner opening of each guider 16S and the upper end of the corresponding limiting block 431S is not less than 110 mm, thereby lowering the limit fixing point between the headrest bracket 12S and the backrest plate 23S, and greatly increasing the deformability of the headrest bracket 12S. Thus, as shown by a dotted line in FIG. 18, FIG. 18 is a schematic view showing a leaning-forward movement of the headrest of the seat according to another embodiment of the present disclosure. When the vehicle is impacted, the deformation of the headrest bracket 12S drives the headrest body 14S of the headrest 10S and the guider 16S to lean forward with the impact force, so that, for the child safety seat according to this embodiment, the headrest 10S can always follow the head of the child during the normal conditions or when the vehicle is impacted, ensuring that the distance between the neck of the child and the vehicle safety belt remains unchanged, reducing the torsion of the vehicle safety belt to the neck, and improving the comfort and safety of the child safety seat.

Based on this embodiment of the holding mechanism 40S, the location of the limiting block 431S is moved from the upper end of the headrest bracket 12S to the lower end of the headrest bracket 12S, increasing the deformability of the headrest 10S. Meanwhile, the overall strength of the headrest 10S and the headrest bracket 12S is not affected, and it still provides sufficient protection for the children siting in the vehicle.

According to a variation of this embodiment, the holding mechanism 40S restricts not only the displacement of the headrest 10S in the front-back direction and left-right direction, but also the displacement of the headrest 10S in the up-down direction. That is, according to a variation of this embodiment, the headrest 10S cannot slide up and down with respect to the backrest portion 22S to adjust the position of the headrest 10S. Based on this embodiment, the location of the limiting block 431S of the holding mechanism 40S is moved from the upper end of the headrest bracket 12S to the lower end of the headrest bracket 12S, thereby increasing the deformability of the headrest 10S.

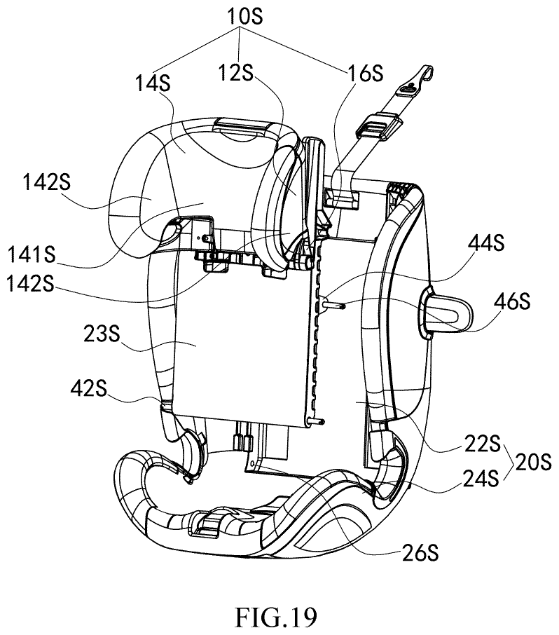

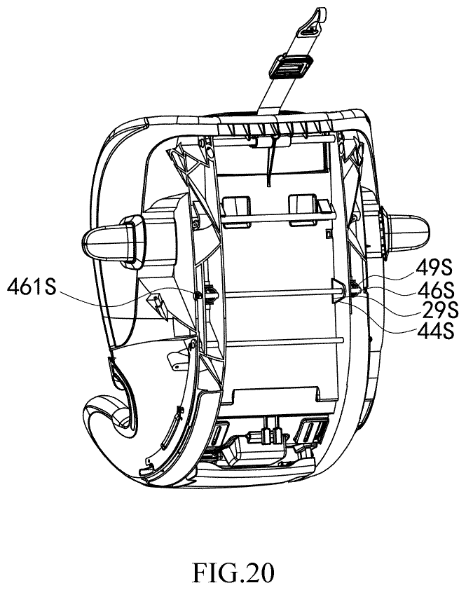

Next, the child safety seat according to another embodiment of the present disclosure will be described. First, the description will be made with reference to FIGS. 19 and 20, wherein FIG. 19 is a schematic front view showing the seat according to yet another embodiment of the present disclosure, and FIG. 20 is a schematic rear view showing the seat according to yet another embodiment of the present disclosure. As shown in FIGS. 19 and 20, similarly to the embodiment described above, the child safety seat 1S according to this embodiment includes a base 30S (not shown in FIGS. 19 and 20), a seat body 20S, and a headrest 10S. The base 30S is configured to be fixedly arranged on the vehicle seat. The seat body 20S is arranged on the base 30S and includes a backrest portion 22S and a seat portion 24S. The backrest portion 22S of the seat body 20S includes a backrest plate 23S. The headrest 10S arranged on an upper part of the seat body 20S and includes a headrest bracket 12S, a headrest body 14S, and a guider 16S arranged on the headrest bracket 12S. The headrest 10S is configured to slide up and down with respect to the backrest portion 22S to adjust a position of the headrest 10S, so as to meet the riding requirements of children with different heights. The headrest body 14S includes a backrest 141S and two side wings 142S, and the guider 16S is arranged at a lower end of the side wing 142S. According to this embodiment, since the child safety seat is configured to be used in booster mode of use, in which, the vehicle safety belt passes through the guider 16S arranged on the headrest 10S, then passes by the chest of the child, and is fixed on the vehicle seat.

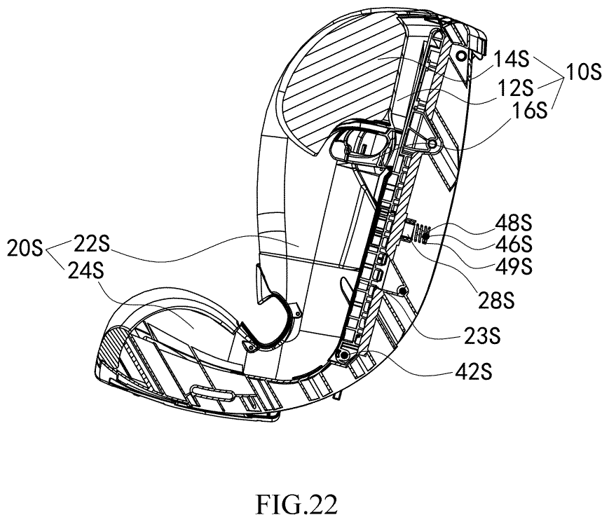

The child safety seat 1S according to some embodiment of the present disclosure shown in FIG. 19 to FIG. 23 is provided with a holding mechanism 40S, which enables the headrest 10S to lean forward when the child safety seat 1S is impacted by an external force. Unlike another embodiment in which the limit fixing point is lowered, in this yet another embodiment, the headrest bracket 12S, the headrest body 14S and the guider 16S are driven by the backrest plate 23S to pivot about the pivot axis and lean forward. Specifically, the holding mechanism 40S includes a pivot shaft 42S, a fixing sheet 44S, a limiting rod 46S, and a limiting chute 48S. The pivot shaft 42S passes through the lower end of the backrest plate 23S of the child safety seat 1S, that is, is located at the lower end of the backrest plate 23S. Two ends of the pivot shaft 42S extend from the backrest plate 23S respectively, and correspondingly, a pivot hole 26S is provided at the corresponding position of the seat body 20S, and extended ends of the pivot shaft 42S are respectively connected with the pivot holes 26S on the seat body 20S, so that the backrest plate 23S is configured to pivot in the front-back direction of the child safety seat 1S with respect to the seat body 20S at the pivot shaft 42S. The fixing sheet 44S is fixed on the backrest plate 23S and located at a rear side of the backrest plate 23S. For example, the fixing sheet 44S is fixed on a back surface of the backrest plate 23S, and the fixing sheet 44S is provided with a perforation 441S. The limiting rod 46S passes through the seat body 20S and the perforation 441S on the fixing sheet 44S, so that the backrest plate 23S, the headrest 10S and the seat body 20S are connected together through the fixing sheet 44S. The limiting chute 48S (as shown in FIG. 22) is provided on the seat body 20S, and the limiting rod 46S is configured to slide in the limiting chute 48S. The limiting rod 46S is located above the pivot shaft 42S, for example, the limiting rod 46S is located in the middle portion of the backrest plate 23S in the longitudinal direction.

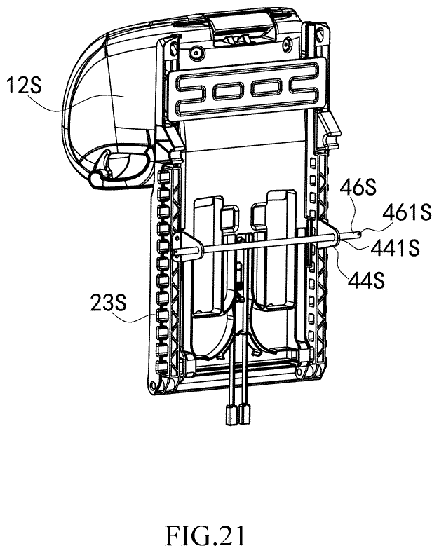

Referring to FIG. 21 again, FIG. 21 is a schematic view showing the holding mechanism 40S according to yet another embodiment of the present disclosure. The holding mechanism 40S according to some embodiment further includes an elastic element 49S arranged between a back surface of the seat body 20S and the limiting rod 46S, and the elastic element 49S tends to push the limiting rod 46S backward under normal conditions, that is, enabling the limiting rod 46S to face away from the back surface of the seat body 20S, and further drives the backrest plate 23S fixedly connected with the limiting rod 46S, making the back surface of the backrest plate 23S contacts the seat body 20S. In addition, FIG. 21 also shows an opening 29S provided in the seat body 20S, and a position of the opening 29S corresponds to a position of the fixing sheet 44S, so that the fixing sheet 44S passes through the opening 29S and is exposed to the back surface of the seat body 20S, and in this way, the backrest plate 23S, the headrest 10S and the seat body 20S are connected together.

The elastic element 49S is a spring, an aluminum honeycomb panel, an elastic sheet, an elastic plastic body, or an eps buffer. In addition, as shown in FIG. 21, each of two ends of the limiting rod 46S is provided with an inserting hole 461S, and a pin (not shown) is inserted into the insertion hole 461S to limit each of the two ends of the limiting rod 46S. In addition, the seat body 20S is provided with a limiting ring 28S (as shown in FIG. 22), and the elastic element 49S is sleeved on the limiting ring 28S, so that the elastic element 49S is positioned radially and arranged obliquely from back to front.

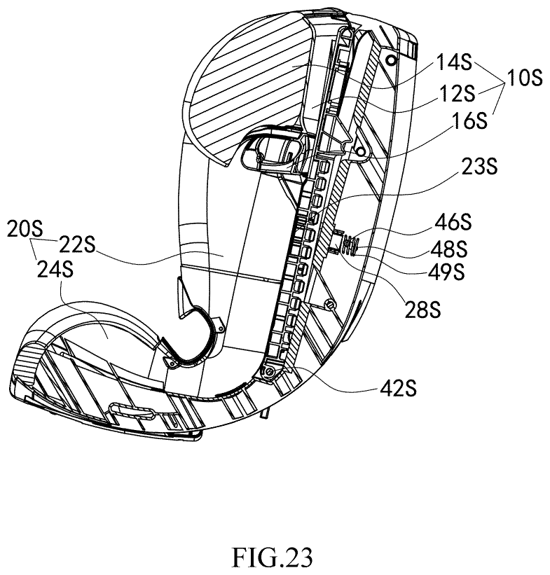

Next, actions of the holding mechanism according to this embodiment in different states will be described with reference to FIGS. 22 and 23, in which FIG. 22 is a schematic view showing that the holding mechanism according to yet another embodiment of the present disclosure is in a first state, FIG. 23 is a schematic view showing that the holding mechanism according to yet another embodiment of the present disclosure is in a second state. The state shown in FIG. 22 is that the vehicle is in a normal state. As shown in FIG. 22, the limiting rod 46S is at a rear end position of the limiting chute 48S, and under the action of the elastic element 49S, the limiting rod 46S is pushed backward along with the backrest plate 23S.

When the vehicle is impacted, as shown in FIG. 23, under the impact force, the limiting rod 46S moves forward along the limiting chute 48S against a thrust force of the elastic element 49S, so as to be at the front end of the limiting chute 48S. At the same time, the pivot shaft 42S at the lower end of the backrest plate 23S starts to rotate, so that the backrest plate 23S is allowed to pivot forward along the front-back direction of the child safety seat IS based on the arrangement of the pivot shaft 42S and the limiting rod 46S, and the backrest plate 23S, the headrest bracket 12S, the headrest body 14S and the guider 16S may also follow the movement of the head of the child when the impact occurs, ensuring the distance between the neck and the vehicle safety belt unchanged, and solving the problem that the vehicle safety belt applies a torsion to the neck. In the embodiment as shown, the limiting chute 48S is inclined upward from back to front. Under the action of the impact force, the limiting rod 46S pivots forward with the backrest plate 23S and moves forward along a pivot path in the limiting chute 48S against the thrust force of the elastic element 49S, thereby moving from the rear lower end of the limiting chute 48S to the front upper end of the limiting chute 48S.

Therefore, in the child safety seat 1S according to the present disclosure, the headrest 10S is provided to be easily deformed or the backrest plate 23S is provided to be pivotable with respect to the seat body 20S, thereby avoiding the rigid resistance existing in the prior art, avoiding the torsion force generated by the rigid resistance on the neck of the child when being impacted, and improving the use comfort and safety of the child safety seat. The present disclosure provides a holding mechanism, which can reduce the torsion of a vehicle seat belt to the neck when the seat is impacted, and a seat including the holding mechanism, so as to improve the comfort and safety of the seat.

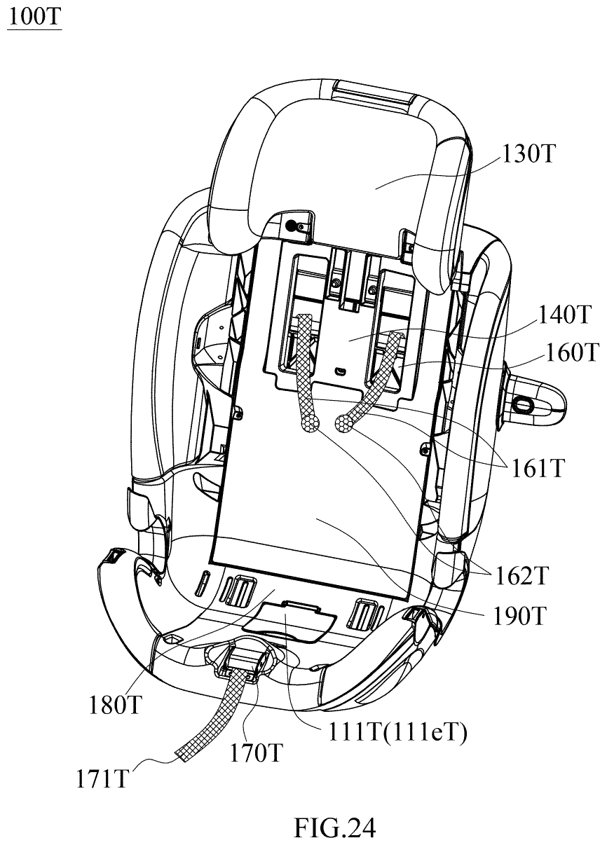

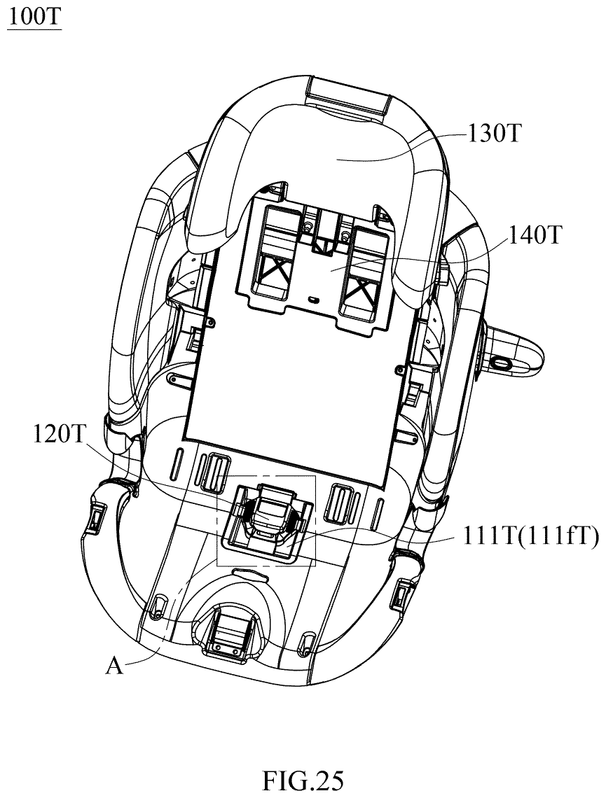

Description will be made with reference to FIGS. 24 and 25. The present disclosure further intends to avoid misusing a height of the headrest effectively by avoiding parents from adjusting the headrest too high while a younger child is sitting in the child safety seat or avoiding the parents from adjusting the headrest too low while an older child is sitting in the child safety seat, and then contributes to improve safety and comfortableness of the child in the safety seat. Receiving the crotch belt buckle or not is used to limit the height of the headrest and adjust a length of a shoulder belt, so as to avoid misusing fasteners on the child safety seat and safety belts of a vehicle. Herein, an inner side of the seat body refers to a side in which the child may sit, correspondingly, an outer side of the seat body is a side opposite to the inner side.

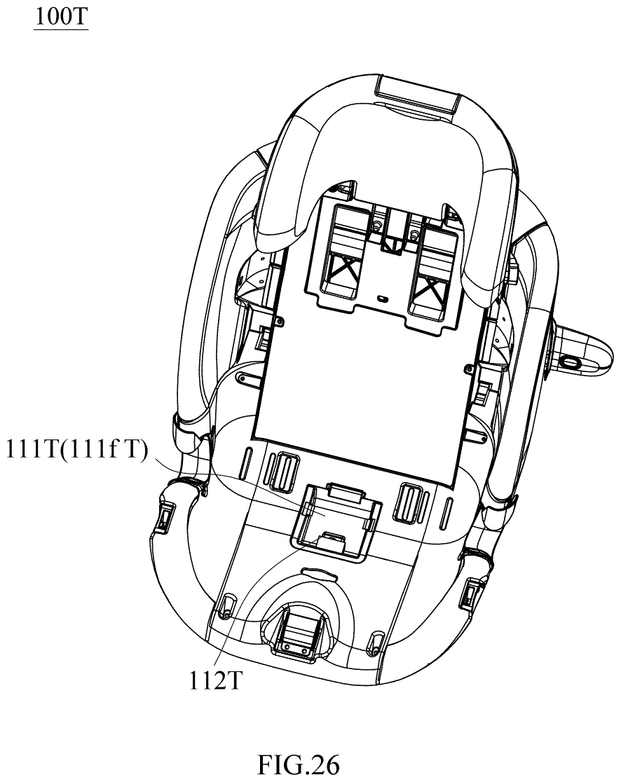

FIGS. 24-25 show a crotch belt buckle receiving device 111T, which is arranged in a seat portion 180T of a child safety seat 100T, and has a receiving slot 111fT for receiving a crotch belt buckle 120T and a trigger 112T arranged in the receiving slot 111fT. The crotch belt buckle 120T is connected to the child safety seat 100T through a belt. The crotch belt buckle receiving device 111T further includes a receiving cover 111eT for covering an opening of the receiving slot 111fT of the crotch belt buckle receiving device 111T to ensure flatness of the seat portion 180T of the child safety seat 100T. The receiving cover 111eT is hinged to the seat portion 180T. A headrest bracket 140T of the child safety seat 100T is provided with a shoulder belt perforation 160T through which the shoulder belt 161T may pass. The crotch belt buckle receiving device 111T further includes a locking member 170T for controlling locking and unlocking of an adjusting belt 171T. One end of the shoulder belt 161T exposed from the shoulder belt perforation 160T is connected with the shoulder belt buckle 162T, and the other end of the shoulder belt is connected with an end of the adjusting belt 171T which is not exposed from the locking member 170T. The length of the shoulder belt 161T is adjusted by extension and retraction of the adjusting belt 171T to adapt to various heights of the children, and then is locked by the locking member 170T when the adjustment is appropriate. The crotch belt buckle 120T is connected to the seat portion 180T through a belt. FIG. 26 shows that a trigger 112T that is movable between an extended position and a retracted position relative to an inner side wall of the receiving slot 111fT is arranged in the receiving slot 111fT.

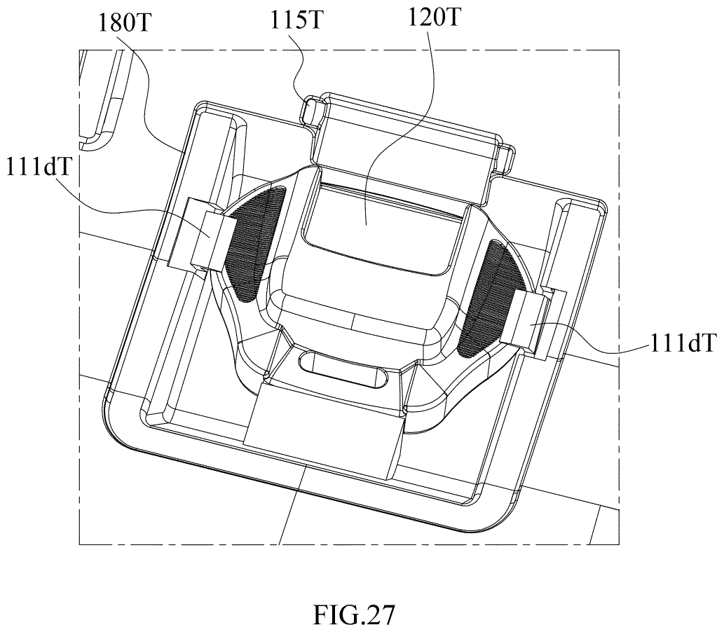

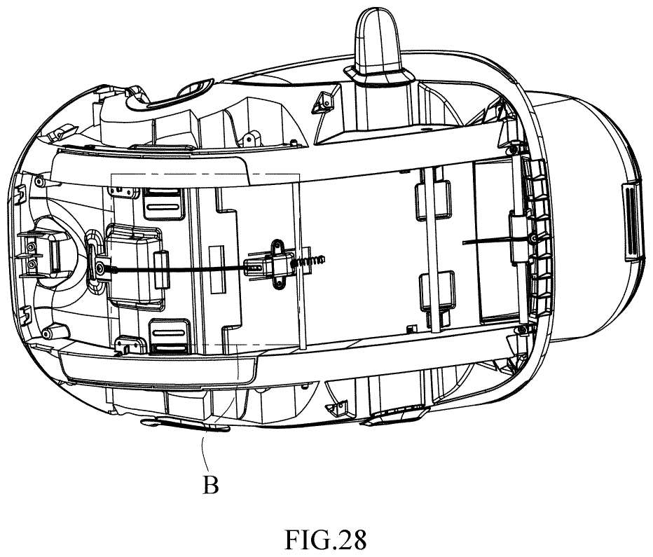

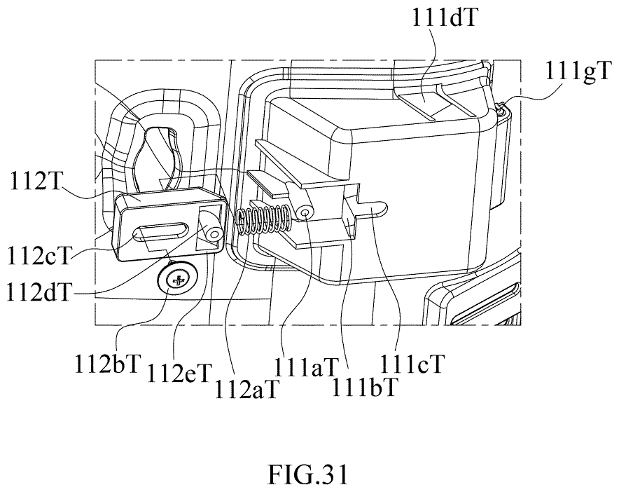

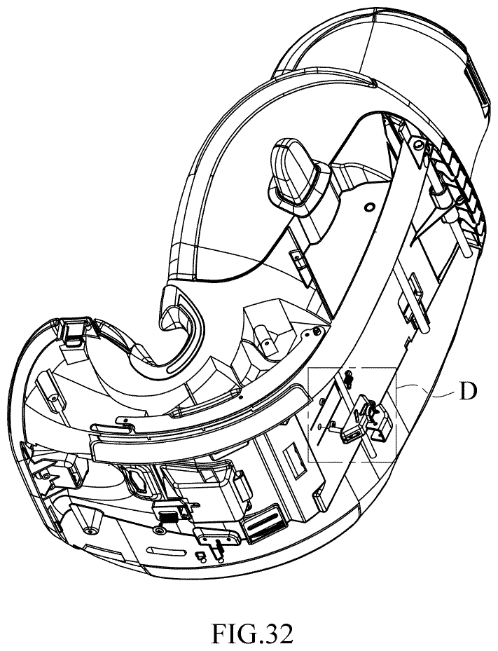

As shown in FIG. 27, elastic fingers 111dT for fixing the crotch belt buckle 120T are arranged at sides of the crotch belt buckle receiving device 111T. An elastic finger 111dT is arranged at either side of the inner wall of the receiving slot 111fT. The seat body 110T is provided with a hinged hole 115T for hinging and fixing to the receiving cover 111eT. The crotch belt buckle receiving device 111T has a receiving cover hinged shaft 111gT (as shown in FIG. 31) connected to the receiving cover 111eT, and the receiving cover hinged shaft 111gT extends into the hinged hole 115T to hinge and fix the receiving cover 111eT. By hinging and fixing the receiving cover 111eT, the receiving cover 111eT is easy to be opened and closed and may not be lost.

As shown in FIG. 31, the crotch belt buckle receiving device 111T is provided with an opening 111bT, through which a trigger end 112eT of the trigger 112T extends into the crotch belt buckle receiving device 111T. Specifically, a wall of the receiving slot 111fT corresponding to the trigger 112T is provided with the opening 111bT, through which the trigger end 112eT of the trigger 112T extends into the receiving slot 111fT. The trigger 112T is provided with a fixing column 112dT for fixing one end of a linkage 113T. A notch 111cT for avoiding the fixing column 112dT is arranged in the receiving slot 111fT of the crotch belt buckle receiving device 111T, and the notch 111cT is communicated with the receiving slot 111fT to allow the trigger 112T move back and forth. The stroke of the trigger 112T is defined by defining the size of the notch 111cT.

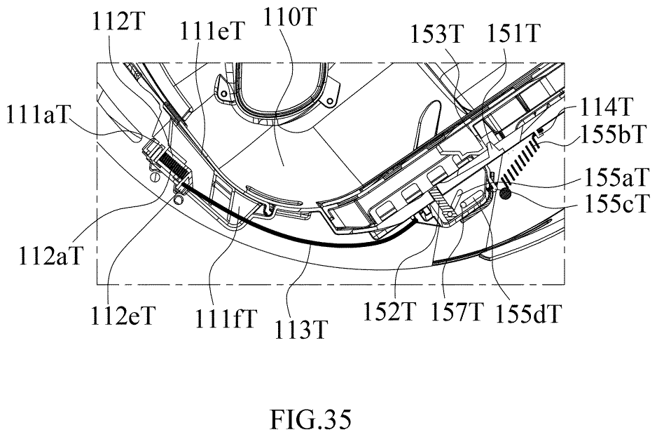

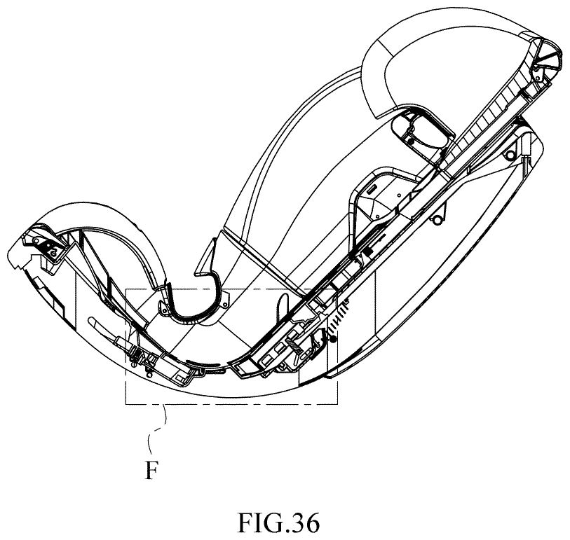

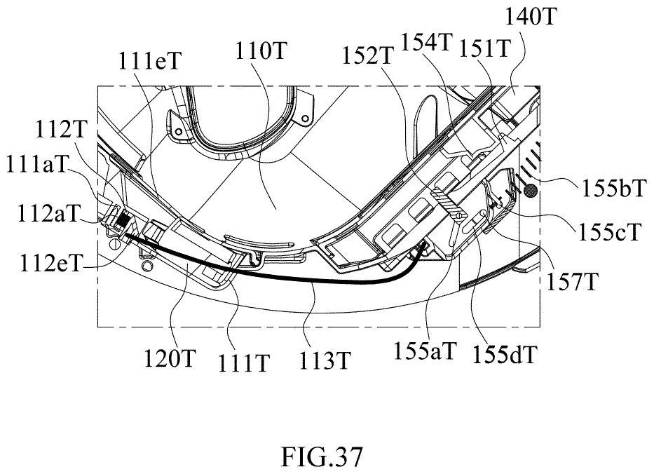

As shown in FIG. 31, FIG. 35 and FIG. 37, a first spring 112aT is arranged inside the trigger 112T such that the trigger 112T is in the extended position while the crotch belt buckle 120T is taken out of the receiving slot 111fT. Specifically, the first spring 112aT exerts a force for moving from the retracted position to the extended position on the trigger 112T, so that the trigger 112T moves to the extended position while taking the crotch belt buckle 120T out. That is, the restoring force of the first spring 112aT forces the trigger 112T to move to the extended position while the crotch belt buckle 120T is taken out of the receiving slot 111fT. As shown in FIG. 31, the trigger 112T is provided with a sliding slot 112cT, and the first spring 112aT is arranged in the sliding slot 112cT. The crotch belt buckle receiving device 111T is provided with a limiting column 111aT, and a limiting screw 112bT is connected with the limiting column 11laT through the sliding slot 112cT. The first spring 112aT has one end that abuts against the inner wall (i.e., the trigger end 112eT) of the sliding slot 112cT and the other end that abuts against the limiting column 111aT. In some embodiment of the present disclosure, the limiting column 111aT is arranged at an outer side of the receiving slot 111fT, and the limiting column 11laT extends into the sliding slot 112cT and limits the trigger 112T together through the limiting screw 112bT connected with a terminal of the limiting column 111aT. A head of the limiting screw 112bT has a width larger than that of the sliding slot 112cT. The limiting screw 112bT is configured to fix the trigger 112T to the receiving slot 111fT and limit the stroke of the trigger 112T.

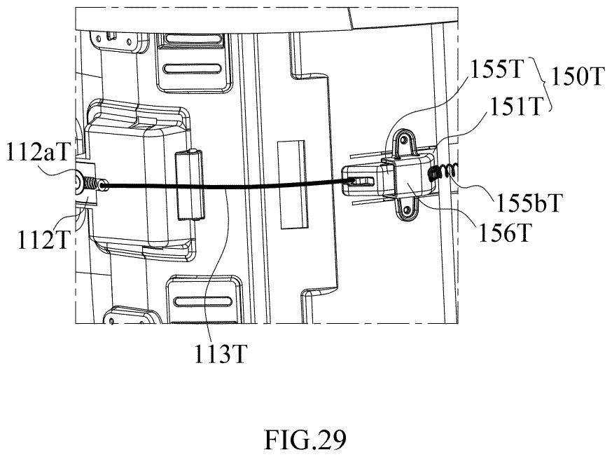

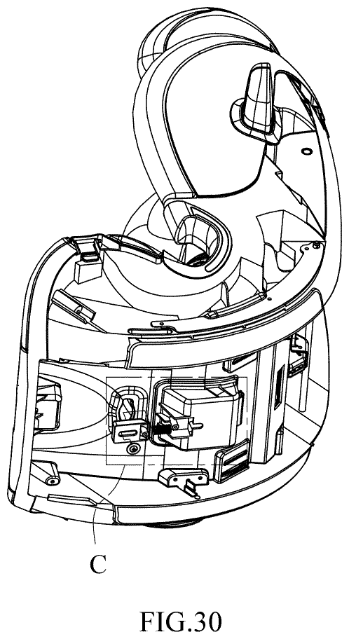

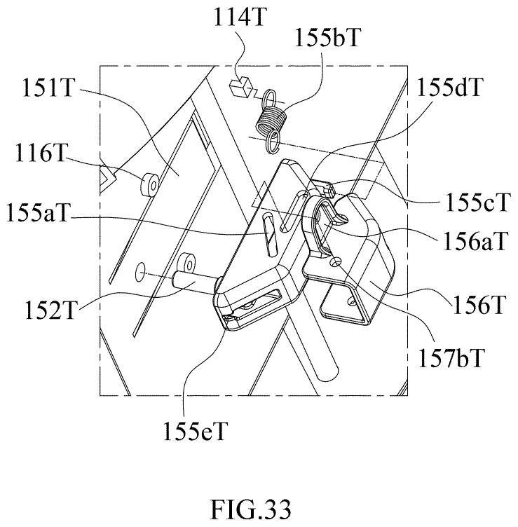

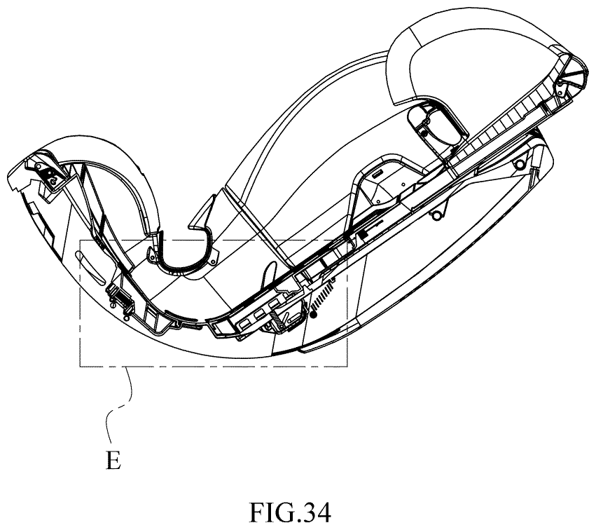

FIG. 29, FIG. 33, FIG. 35, and FIG. 37 show a limiting device 150T, which includes a driving member 155T, a limiting pin 152T, an elastic catch 151T, an upper limiting step 153T, a lower limiting step 154T, and a pin 157T. The driving member 155T is mounted on the backrest 190T and is movable relative to the backrest 190T. The limiting pin 152T is installed on the backrest 190T and is movable relative to the driving member 155T. The elastic catch 151T is arranged on the backrest 190T and into which the limiting pin 152T is disposed. The upper limiting step 153T and the lower limiting step 154T are provided on the headrest 130T.

The driving member 155T is provided with a driving chute 155aT for driving the action of the limiting pin 152T. The driving chute 155aT extends in a direction not parallel to a moving direction of the driving member 155T, and one end of the limiting pin 152T is coupled to the driving chute 155aT, such that it is movable along the driving chute 155aT relative to the driving member 155T.

As shown in FIG. 29, a second spring 155bT is connected between the backrest 190T and the driving member 155T to reset the driving member 155T while the crotch belt buckle 120T is taken out of the receiving slot 111fT. The second spring 155bT exerts a force on the driving member 155T so as to pull it toward the headrest 130T. As shown in FIGS. 33 and 35, the backrest 190T is provided with a hook 114T for fixing one end of the second spring 155bT. The driving member 155T is provided with a fixing hook 155cT for fixing the other end of the second spring 155bT.

As shown in FIG. 29, the driving member 155T is provided with a fixing cover 156T for limiting a direction of the driving member 155T transverse to a linkage direction. Herein, the linkage direction refers to a direction in which the driving member 155T is pulled by the second spring 155bT or the linkage 113T. The fixing cover 156T is fixed to the backrest 190T and covered on the driving member 155T, and the driving member 155T is movable inside the fixing cover 156T. As shown in FIG. 33, FIG. 35 and FIG. 37, one of the driving member 155T and the fixing cover 156T is provided with a limiting slot 155dT that extends along the moving direction of the driving member 155T, and the other of the driving member 155T and the fixing cover 156T is provided with a limiting hole 157bT, and the pin 157T is inserted into the limiting hole 157bT and the limiting slot 155dT. The limiting slot 155dT cooperates with the limiting pin 157T to limit the stroke of the driving member 155T in the linkage direction. The pin 157T is inserted into the limiting slot 155dT and is movable along the limiting slot 155dT. As shown in FIG. 33, the fixing cover 156T is provided with a fixing lug 156aT for fixing the fixing cover 156T to the seat body 110T, and the seat body 110T is provided with a fixing boss 116T matched with the fixing lug 156aT to fix the fixing cover 156T.

As shown in FIG. 29, the trigger 112T is linked with the limiting device 150T through the linkage 113T, so that as shown in FIG. 37, when the crotch belt buckle 120T is received in the receiving slot 111fT of the crotch belt buckle receiving device 111T, the trigger 112T is in its retracted position, and the limiting device 150T limits the lower limit stroke of the headrest 130T of the child safety seat 100T relative to the backrest 190T of the seat body 110T; as shown in FIG. 35, when the crotch belt buckle 120T is not received in the receiving slot 111fT of the crotch belt buckle receiving device 111T, the trigger 112T is in its extended position, and the limiting device 150T limits the upper limit stroke of the headrest 130T relative to the backrest 190T.

As shown in FIG. 31, the trigger 112T is provided with the fixing column 112dT for fixing one end of the linkage 113T, and the driving member 155T is provided with a fixing slot 155eT for fixing the other end of the linkage 113T (as shown in FIG. 33).

As shown in FIG. 29, the linkage 113T is a steel wire to link the trigger 112T with the driving member 155T. In some embodiment, the linkage 113T is a flexible rope. the linkage 113T (steel wire or flexible rope, as a specific example) transmits a pulling force generated where the trigger 112T is pressed by the crotch belt buckle 120T to pull the driving member 155T, and the linkage 113T is pushed by the first spring 112aT and pulled by the second spring 155bT while the crotch belt buckle 120T is taken out of the crotch belt buckle receiving device 111T. That is, restoring force directions of the first spring 112aT and the second spring 155bT are the same.

The working process of the present disclosure will be described below:

When the crotch belt buckle 120T is not placed in the crotch belt buckle receiving device 111T as shown in FIG. 35, the driving member 155T is pulled by the second spring 155bT, so that the limiting pin 152T is in a retracted position under the action of the driving chute 155aT (the driving chute 155aT forces the limiting pin 152T to be retracted along with the movement of the driving member 155T). No matter that the driving member 155T moves or stops in the fixing cover 156T (the limiting slot 155dT cooperates with the pin 157T to limit the stroke of the driving member 155T in the linkage direction), the elastic catch 151T is pressed against the inner side of the seat body 110T (so that the elastic catch 151T cannot move toward the outer side of the seat body 110T). Meanwhile, the elastic catch 151T and the upper limiting step 153T of the headrest 130T form a blocking limit, to limit the upper limit stroke of the headrest 130T, and the trigger 112T is pulled by the linkage 113T to protrude out of the inner side wall of the receiving slot 111fT.

When the crotch belt buckle 120T is placed in the crotch belt buckle receiving device 111T as shown in FIG. 37, the trigger 112T is pressed by the crotch belt buckle 120T to drive the linkage 113T, and the linkage 113T pulls the driving member 155T to allow the limiting pin 152T to protrude under the action of the driving chute 155aT (the driving chute 155aT moves along with the driving member 155T to force the limiting pin 152T to protrude) to form the blocking limit with the lower limiting step 154T of the headrest 130T, so as to limit the lower limit stroke of the headrest 130T. As the driving member 155T is pulled by the linkage 113T to move in a direction approaching the seat portion 180T, as shown in FIG. 37, the driving member 155T is no longer pressed against the elastic catch 151T, so that the elastic catch 151T can be elastically deformed. In this case, when the headrest 130T is adjusted upward, the upper limiting step 153T is allowed to pass over the elastic catch 151T to adjust the headrest 130T upward.

In other words, when the trigger 112T is in its retracted position, the driving member 155T moves along the direction approaching the seat portion 180T under the action of the linkage 113T, and the limiting pin 152T is movable relative to the driving chute 155aT to extend into the backrest 190T, and may abut against a lower side of the lower limiting step 154T of the headrest 130T to prevent the headrest 130T from moving downward relative to the backrest 190T. When the trigger 112T is in its extended position, the driving member 155T moves away from the seat portion 180T, and the limiting pin 152T is movable relative to the driving chute 155aT to distance away from the backrest 190T. The elastic catch 151T may abut against an upper side of the upper limiting step 153T of the headrest 130T to prevent the headrest 130T from moving upward relative to the backrest 190T. That is, in a harness use mode, as shown in FIG. 35, the crotch belt buckle 120T is not placed in the crotch belt buckle receiving device 111T, the driving member 155T is pressed against the elastic catch 151T, so that the elastic catch 151T blocks the upper limiting step 153T of the headrest 130T; in a booster use mode, as shown in FIG. 37, the crotch belt buckle 120T is placed in the crotch belt buckle receiving device 111T, the driving member 155T is not pressed against the elastic catch 151T, so that the elastic catch 151T can be elastically deformed. In this case, when the headrest 130T is adjusted upward, the upper limiting step 153T can pass over the elastic catch 151T.

The child safety seat 100T as shown in FIG. 24 includes a seat body 110T and a headrest 130T, wherein the crotch belt buckle receiving device 111T as described above is arranged to the seat portion 180T of the seat body 110T. The child safety seat 100T has a harness use mode and a booster use mode. In the harness use mode, the crotch belt buckle 120T is not received in the crotch belt buckle receiving device 111T, and in the booster use mode, the crotch belt buckle 120T is received in the crotch belt buckle receiving device 111T.

As mentioned above, it is desired to switch to the booster use mode, according to the present disclosure, even if the headrest 130T is mistakenly adjusted downward, the parents can only adjust the headrest 130T to the lowest position in the booster use mode at most (the limiting pin 152T protrudes out and forms the blocking limit with the lower limiting step 154T to limit the lower limit stroke of the headrest 130T). That is, the headrest 130T cannot be adjusted to a lower position in the harness use mode, which can ensure the adjustment of the height of the headrest 103T and the length of the shoulder belt 161T only within shift positions in the booster use mode. At the same time, the shoulder belt 161T penetrates through the headrest bracket 140T, such that the length of the shoulder belt 161T is lengthened synchronously.

In the booster use mode, it is necessary to receive the crotch belt buckle 120T in the receiving slot 111fT, the upper limit stroke of the headrest 130T is released (since the driving member 155T is not pressed against the elastic catch 151T, the elastic catch 151T is elastically deformed, in this case, when the headrest 130T is adjusted upward, the upper limiting step 153T may across the elastic catch 151T, the upper limit stroke is released), as such, the headrest 130T and the shoulder belt 161T is adjusted to a proper height and length, and the lower limit stroke of the headrest 130T is limited to prevent the headrest 130T from being adjusted to an excessively low shift position. In the harness use mode, since the crotch belt buckle 120T and the shoulder belt buckle 162T are configured for fixing, after the crotch belt buckle 120T is taken out of the receiving slot 111fT, the upper limit stroke of the headrest 130T is limited by the limiting device 150T to prevent the headrest 130T from being adjusted upward too much. This can ensure the accuracy in the two use modes, further ensure the safety in use and avoid misuse.

In other words, in the harness use mode, since the crotch belt buckle 120T is used in cooperation with the shoulder belt buckle 162T, the crotch belt buckle 120T is not placed in the receiving slot 111fT, at this time, the driving member 155T is pulled by the second spring 155bT, so that the limiting pin 152T is in a retracted position, and the driving member 155T is pressed against the elastic catch 151T inwardly, and the trigger 112T is pulled by the linkage 113T to protrude out of the inner side wall of the receiving slot 111fT, and at the same time, the elastic catch 151T and the upper limiting step 153T of the headrest 130T form a blocking limit, to limit the upper limit stroke of the headrest 130T, so that the headrest 130T cannot be adjusted upward, that is, being always in the harness use mode at a low shift position. In the booster use mode, since the crotch belt buckle 120T is to be placed in the receiving slot 111fT, the trigger 112T is pressed by the crotch belt buckle 120T to drive the linkage 113T, and the linkage 113T pulls the driving member 155T to allow the limiting pin 152T to protrude, and form a blocking limit with the lower limiting step 154T of the headrest 130T, to limit the lower limit stroke of the headrest 130T, such that the headrest 130T cannot be adjusted downward, that is, being always in the booster use mode at a high shift position. When the booster use mode of the child safety seat is used by an elder child, and the crotch belt buckle 120T is used, it is found that the child's head is higher than the headrest 130T, and the headrest 130T cannot be adjusted upward, this may remind the parents to place the crotch belt buckle in the receiving slot 111fT and use the safety belt of the vehicle. Relatively, when the harness use mode of the child safety seat is used by a younger child, and the safety belt of the vehicle is used at this time, it is found that the child's head is lower than the headrest 130T, and the headrest 130T cannot be adjusted downward, this may remind the parents to use the crotch belt buckle 120T instead of the safety belt of the vehicle.

In an aspect, the present disclosure provides a base for a child safety seat. The base includes: a housing; a base bracket received in the housing; and an anchor assembly telescopically and pivotably connected to the base bracket, and at least partially extends out of the housing.

In one embodiment, the anchor assembly includes a pivot shaft, and the base bracket is provided with a first sliding groove. The pivot shaft is slidably arranged in the first sliding groove to form a pivot point.

In one embodiment, the anchor assembly further includes a connecting part. The connecting part may be anchored to a fixing rod of a seat of a vehicle to form an anchoring point.

In one embodiment, the anchor assembly further includes a sliding part. The pivot shaft is located at an end of the sliding part, and the connecting part is fixedly connected to the other end of the sliding part, so that a distance is formed between the pivot point and the anchoring point to generate an arm of force for bearing a force when the base is impacted, so as to have a buffering function.

In one embodiment, the sliding part includes a reinforcement element fixedly connected to the sliding part to enhance strength of the anchor assembly.

In one embodiment, the connecting part is an ISOFIX fixing element.

In one embodiment, the base further includes a limiting press block and a reset element. The limiting press block is pivotably connected to the base bracket. The reset element is connected to the base bracket and the limiting press block to keep applying a reset force to the limiting press block.

In one embodiment, a limiting groove is formed on the base bracket to limit a pivot angle of the limiting press block.

In one embodiment, the limiting press block includes a limiting hole constrained within a range of the limiting groove.

In one embodiment, the limiting press block includes a second sliding groove, the anchor assembly includes a connecting rod, and the base bracket includes a rotary limiting groove. The connecting rod passes through the second sliding groove and the rotary limiting groove.

In one embodiment, the limiting press block and the anchor assembly are located at opposite sides of the rotary limiting groove respectively.

In one embodiment, two limiting press blocks and two anchor assemblies are provided, the base bracket includes two rotary limiting grooves, and each of the two limiting press blocks includes one second sliding groove, wherein the two anchor assemblies are connected via a connecting rod, and the connecting rod passes through the two second sliding grooves and the two rotary limiting grooves.

In one embodiment, two limiting press blocks and two anchor assemblies are provided, the base bracket includes two rotary limiting grooves, each of the two limiting press block includes one second sliding groove, and each of the two anchor assemblies includes one connecting rod. Each of connecting rods passes through one of the second sliding grooves and one of the rotary limiting grooves.

In one embodiment, a direction in which the anchor assembly extends out of the housing is defined as a backward direction, the rotary limiting groove is positioned in a front-back direction, and a size of the rotary limiting groove gradually increases from front to back.

In one embodiment, the base further includes a telescopic adjusting assembly, and the anchor assembly includes a plurality of locking holes. The telescopic adjusting assembly is selectively engaged to one of the locking holes.

In one embodiment, the telescopic adjusting assembly includes a telescopic adjusting handle, a linkage arm and a locking pin. The telescopic adjusting handle is connected to the locking pin via the linkage arm, so that movement of the telescopic adjusting handle disengages the locking pin from one of the locking holes.

In one embodiment, the telescopic adjusting handle is at least partially exposed out of the housing.

In one embodiment, the linkage arm is formed in an “L” shape.

In one embodiment, one end of the linkage arm is connected to the locking pin, the other end of the linkage arm is pivotably connected to the telescopic adjusting handle, and the linkage arm is pivotable around a part between the one end and the other end thereof.

In one embodiment, the telescopic adjusting assembly further includes a reset element which tends to engage the locking pin with one of the locking holes.

In one embodiment, the base has two anchor assemblies. A connecting rod is formed between the two anchor assemblies to keep movements of the two anchor assemblies synchronized.

On the other hand, the present disclosure provides a base. The base includes a housing enclosing a space; a base bracket arranged in the space and forming a first sliding groove; and an anchor assembly having a pivot shaft located in the first sliding groove to form a pivot point.

In one embodiment, the anchor assembly has a horizontal state and a tilted state. The anchor assembly is parallel to a bottom surface of the housing when it is in the horizontal state, and forms an angle with the bottom surface of the housing when it is in the tilted state.

In one embodiment, the anchor assembly has an extended position and a retracted position. The anchor assembly extends more out of the housing in the extended position than in the retracted position.

In one embodiment, the base bracket includes two symmetrical sheets, and a base bracket connecting rod is formed between the two sheets to maintain a fixed distance between the two sheets.

In one embodiment, the base includes two anchor assemblies, each of the sheets forms one of the first sliding grooves, and a pivot shaft of each of the two anchor assemblies is located in one of the two first sliding grooves.

In one embodiment, the base further includes two limiting press blocks pivotably connected to the two sheets of the base bracket respectively. Each of the two limiting press blocks applies a restoring force to one of the two anchor assemblies, tending to keep each of the two anchor assemblies in a horizontal state.

In one embodiment, each of the two anchor assemblies includes a reinforcement element, a part of the reinforcement element extends vertically upwards and is formed on a side of the sheet opposite to the limiting press block, and the reinforcement element is formed as a sheet.

In one embodiment, each of the sheets of the base bracket includes a rotary limiting groove. A connecting rod passes through the rotary limiting groove of each of the sheets to connect reinforcement elements of the two anchor assemblies.

In one embodiment, each of the two limiting press blocks is formed with a second sliding groove, and the connecting rod passes through second sliding grooves of the two limiting press blocks.

In one embodiment, each of the sheets of the base bracket includes a rotary limiting groove. Each of two connecting rods passes through the rotary limiting groove of one of the two sheets to connect the reinforcement element of one of the two anchor assemblies.

In one embodiment, each of the two limiting press blocks is also formed with a second sliding groove, and each of the two connecting rods passes through the second sliding groove of one of the two limiting press blocks.

In one embodiment, a plurality of locking holes are formed on each of reinforcement elements. The base further includes a telescopic adjusting assembly including two locking pins, and each of the two locking pins is operably inserted into one of the plurality of locking holes on each of the reinforcement elements, so that the two anchor assemblies is fixed in the extended position, or in the retracted position, or in any of one or more other positions between the extended position and the retracted position.

In one embodiment, connecting rod is formed between the two anchor assemblies to keep telescopic movements of the two anchor assemblies synchronized.

In one embodiment, the telescopic adjusting assembly includes a telescopic adjusting handle. The telescopic adjusting handle may be actuated to disengage the two locking pins from the corresponding locking holes simultaneously.

In one embodiment, the telescopic adjusting handle at least partially extends out of the housing, or the telescopic adjusting handle is at least partially exposed from bottom of the housing.

In one embodiment, the telescopic adjusting handle is provided with a recess recessed into the space.

In yet another aspect, the present disclosure provides a child safety seat. The child safety seat includes a base according to the above; and a seat body located above the base.

In one embodiment, the seat may rotate relative to the base.

In one embodiment, an adjusting sliding slot is formed on the base bracket of the base, and a part of the seat body is located in the adjusting sliding slot, so that the seat body may slide relative to the base.

According to an aspect of the present disclosure, a seat is provided. The seat includes a seat body including a backrest portion. The backrest portion includes a backrest plate; a headrest arranged on an upper part of the seat body, and including a headrest bracket and a headrest body arranged on the headrest bracket, wherein the headrest bracket is connected to the backrest plate; and a holding mechanism enabling the headrest to lean forward when being impacted by an external force.

In one embodiment, the headrest moves upward and downward relative to the backrest portion to adjust a position of the headrest, and the holding mechanism restricts a displacement of the headrest in a front-back direction and in a left-right direction.

In one embodiment, a limit fixing point between the headrest bracket and the backrest plate is arranged below a middle portion of the headrest bracket in a longitudinal direction.

In one embodiment, the headrest includes a guider arranged at a lower end of the headrest body, and a vertical distance between a lower edge of an inner opening of the guider and an upper end of the limit fixing point is not less than 110 mm.

In one embodiment, the holding mechanism includes at least one limiting block arranged on the headrest bracket, and the limiting block is arranged below a middle portion of the headrest bracket in a longitudinal direction; at least one guide rail is arranged on the backrest plate corresponding to the limiting block, and the limiting block slides in the guide rail and is arranged below the middle portion of the headrest bracket in the longitudinal direction.

In one embodiment, the holding mechanism includes two limiting blocks arranged on both sides of the headrest bracket, and the limiting blocks are arranged below a middle portion of the headrest bracket in a longitudinal direction; two guide rails are respectively arranged on both sides of the backrest plate corresponding to the limiting blocks, and each of the limiting blocks slides in one of the guide rails, and the limiting blocks are arranged below the middle portion of the headrest bracket in the longitudinal direction.

In one embodiment, the holding mechanism includes two guide rails arranged on both sides of the headrest bracket; two limiting blocks are respectively arranged on both sides of the backrest plate corresponding to the guide rails, the guide rails are arranged below a middle portion of the headrest bracket in a longitudinal direction, and each of the limiting blocks slides in one of the guide rails.

In one embodiment, the headrest includes at least one guider arranged at a lower end of the headrest body, and a vertical distance between a lower edge of an inner opening of the guider and an upper end of a corresponding one of the limiting blocks is not less than 110 mm.

In one embodiment, the holding mechanism enables the backrest plate to lean forward when being impacted by an external force, and includes a pivot mechanism for pivotally connecting the backrest plate to the seat body via a lower end of the backrest plate; and a limiting mechanism for keeping the backrest plate in a first state when the backrest plate is not impacted by the external force, and allowing the backrest plate to lean forward to be in a second state when the backrest plate is impacted by the external force.

In one embodiment, the pivot mechanism includes a pivot shaft passing through a lower end of the backrest plate of the seat and is connected with a pivot hole on the seat body of the seat at both sides respectively.

In one embodiment, the limiting mechanism includes: a fixing sheet fixed on a back side of the backrest plate and provided with a perforation; a limiting rod passing through the seat body and the perforation on the fixing sheet to connect the backrest plate, the headrest and the seat body together; a limiting chute arranged on the seat body, wherein the limiting rod slides in the limiting chute; and an elastic element arranged between the seat body and the limiting rod.

In one embodiment, the seat body is provided with a limiting ring, the elastic element is sleeved on the limiting ring to radially position the elastic element.

In one embodiment, the elastic element is a spring, an aluminum honeycomb panel, an elastic sheet, an elastic plastic body, or an EPS buffer.

In one embodiment, each of two ends of the limiting rod is provided with an inserting hole, and a pin is inserted into the inserting hole to limit each of the two ends of the limiting rod.

In one embodiment, the seat body is provided with an opening for the fixing sheet to pass through the seat body.

According to another aspect of the present disclosure, a holding mechanism is provided. The holding mechanism is installed in a seat, the holding mechanism enables a headrest of the seat to lean forward when the seat is impacted by an external force, and the holding mechanism includes: a pivot shaft passing through a lower end of the backrest plate of the seat and connected with pivot holes on a seat body of the seat at both sides respectively; a fixing sheet fixed on a back side of the backrest plate and provided with a perforation; a limiting rod passing through the seat body and the perforation on the fixing sheet to connect the backrest plate, the headrest and the seat body together; and a limiting chute arranged on the seat body, wherein the limiting rod slides in the limiting chute.

In one embodiment, the holding mechanism further includes an elastic element arranged between the seat body and the limiting rod, and the elastic element tends to push the limiting rod in a direction away from the seat body under a normal condition.

In one embodiment, the seat body is provided with a limiting ring, and the elastic element is sleeved on the limiting ring to radially position the elastic element.

In one embodiment, the elastic element is a spring, an aluminum honeycomb panel, an elastic sheet, an elastic plastic body, or an EPS buffer.

In one embodiment, each of two ends of the limiting rod is provided with an inserting hole, and a pin is inserted into the inserting hole to limit each of the two ends of the limiting rod.

In one embodiment, the seat body is provided with an opening for the fixing sheet to pass through the seat body.

According to yet another aspect of the present disclosure, a seat is provided. The seat includes a base; a seat body arranged on the base and comprising a backrest portion, wherein the backrest portion includes a backrest plate; a headrest arranged on an upper part of the seat body, and including a headrest bracket and a headrest body arranged on the headrest bracket. The seat further includes the holding mechanism as described above.

The present disclosure further provides a crotch belt buckle receiving device, arranged in a seat portion of a seat body of a child safety seat and including a receiving slot for receiving a crotch belt buckle, and a trigger arranged in the receiving slot and being movable between an extended position and a retracted position relative to an inner side wall of the receiving slot, and the trigger being linked with a limiting device through a linkage, so that when the crotch belt buckle is received in the receiving slot, the trigger is in the retracted position, and the limiting device limits a lower limit stroke of a headrest of the child safety seat relative to a backrest of the seat body; when the crotch belt buckle is not received in the receiving slot, the trigger is in the extended position, and the limiting device limits an upper limit stroke of the headrest relative to the backrest.

In one embodiment, a first spring is arranged in the trigger, and the first spring always exerts a force on the trigger for moving from the retracted position to the extended position, so that the trigger moves to the extended position while taking the crotch belt buckle out.

In one embodiment, an opening is provided at a wall of the receiving slot corresponding to the trigger, and a trigger end of the trigger extends into the receiving slot through the opening.

In one embodiment, the trigger is provided with a sliding slot, and a limiting column is arranged outside the receiving slot, and the limiting column extends into the sliding slot to limit the trigger.

In one embodiment, the first spring is arranged in the sliding slot, and has one end limited by the trigger end and the other end limited by the limiting column.

In one embodiment, the trigger is provided with a fixing column for fixing one end of the linkage, and the receiving slot is provided with a notch for avoiding the fixing column.

In one embodiment, elastic fingers for fixing the crotch belt buckle are arranged on either sides of an inner wall of the receiving slot.

In one embodiment, the crotch belt buckle receiving device further includes a receiving cover for covering the opening of the receiving slot, and the receiving cover being hinged to the seat portion to ensure flatness of a surface of the seat portion.

In one embodiment, the linkage is a steel wire or another flexible rope to realize linkage between the trigger and the limiting device.

In one embodiment, a limiting screw is connected with a terminal of the limiting column, and a head of the limiting screw has a width larger than that of the sliding slot.

In one embodiment, the limiting device includes a driving member installed on the backrest and movable relative to the backrest; a limiting pin installed on the backrest and movable relative to the driving member; an elastic catch arranged on the backrest, and the limiting pin being inserted into the elastic catch; and an upper limiting step and a lower limiting step, arranged on the headrest.

In one embodiment, the other end of the linkage is fixed to the fixing slot of the driving member.

In one embodiment, a second spring is connected between the backrest and the driving member, and the second spring always exerts a force on the driving member to pull it toward the headrest.

In one embodiment, the backrest is provided with a hook for fixing one end of the second spring, and the driving member is provided with a fixing hook for fixing the other end of the second spring.

In one embodiment, the crotch belt buckle receiving device further includes a fixing cover, which is fixed to the backrest and covers the driving member, and the driving member being movable inside the fixing cover.

In one embodiment, one of the driving member and the fixing cover is provided with a limiting slot extending along a moving direction of the driving member, and the other of the driving member and the fixing cover is provided with a limiting hole, and the limiting device includes a pin, and the pin is inserted into the limiting hole and the limiting slot and is movable along the limiting slot.

In one embodiment, the driving member is provided with a driving chute, the driving chute extends in a direction not parallel to the moving direction of the driving member, and one end of the limiting pin is coupled to the driving chute, so that the limiting pin is movable relative to the driving member along the driving chute.

In one embodiment, when the trigger is in the retracted position, the driving member moves in a direction close to the seat portion under an action of the linkage, and the limiting pin is movable relative to the driving chute to extend into the backrest and abuts against a lower side of the lower limiting step to prevent the headrest from moving downward relative to the backrest; when the trigger is in the extended position, the driving member moves to a direction away from the seat portion, the limiting pin is movable relative to the driving chute to distance away from the backrest, and the elastic catch abuts against an upper side of the upper limiting step to prevent the headrest from moving upward relative to the backrest.

The present disclosure provides a child safety seat, including a seat body and a headrest, wherein a seat portion of the seat body is provided with the crotch belt buckle receiving device.

In one embodiment, the child safety seat has a band-use mode and a raised-use mode, in the band-use mode, the crotch belt buckle is not received in the receiving slot; and in the raised-use mode, the crotch belt buckle is received in the receiving slot.

In one embodiment, the child safety seat further includes a locking member for controlling locking and unlocking of the adjusting belt; a headrest bracket of the headrest being provided with a shoulder belt perforation through which the shoulder belt passes; one end of the shoulder belt allowing a shoulder belt perforation to be exposed and being connected to a shoulder belt buckle; and the other end of the shoulder belt being connected with one end of the adjusting belt without exposing the locking member; and the crotch belt buckle being connected to the seat portion through a braided strap.

With the technical solutions as mentioned above, the present disclosure has at least one of the following advantages:

1. The anchor assembly of the base of the present disclosure may be telescopically adjusted to adapt to different vehicle seats, and it is convenient to be caught and connected with a connector on the vehicle seat. At the same time, one end of the anchor assembly is pivotably connected, so that the child safety seat can well sink after the child sits on the child safety seat, so as to prevent the head of the child for easily hitting the roof of the vehicle, and better protect the child and ensure the use safety of the child safety seat.

2. At the same time, the pivot point of the anchor assembly is far away from a catch point, and the arm of force is longer, so that it can bear greater force when it is impacted, and it can also have a better buffering function, a better safety and a better protection for children.

3. In addition, compared with a sliding iron pipe in the prior art, a weight of the anchor assembly containing the reinforcement element is greatly reduced, facilitating users to carry, install and use, and greatly improving the operation experience of the child safety seat.

4. The anchor assembly may be automatically reset after the child leaves the child safety seat without additional operation, thereby being convenient to use.

5. The anchor assembly may have a plurality of extending lengths, so that the installation position of the child safety seat can be conveniently adjusted.

6. The adjustment of the extending length of the anchor assembly can realize one-handed operation with the telescopic adjusting handle, thereby improving the convenience.

7. The connecting rod is formed between the anchor assemblies in the present disclosure, so that the two anchor assemblies can keep synchronous motion and avoid the base from tilting or causing imbalance during use.

8. According to the child safety seat of the present disclosure, the headrest is provided to be deformable or movable through the holding mechanism, so that when the vehicle is impacted, and the child's head leans forward due to the impact, the headrest will also lean forward, so that the distance between the neck and the vehicle safety belt remains unchanged compared with the distance when the vehicle safety belt is not impacted, thereby greatly reducing the torsion of the vehicle safety belt to the child's neck and improving the comfort and safety of the child safety seat.

9. The present disclosure solves the problems of misuse of three-directional or five-directional fastener in the Booster mode of use, and misuse of the vehicle seat belt in the Harness mode of use.

Other embodiments of the disclosure will be apparent to those skilled in the art from consideration of the specification and practice of the disclosure disclosed herein. This application is intended to cover any variations, uses, or adaptations of the disclosure following, in general, the principles of the disclosure and including such departures from the present disclosure as come within known or customary practice in the art to which the disclosure pertains. It is intended that the specification and examples be considered as exemplary only, with a true scope and spirit of the disclosure being indicated by the following claims.

Although the present disclosure has been described with reference to typical embodiments, the used terms are illustrative and exemplary, rather than restrictive terms. As the present disclosure can be implemented in various forms without departing from the spirit and essence of the present disclosure, it should be understood that the above-mentioned embodiments are not limited to any of the foregoing details, but should be interpreted as broad as possible within the scope defined by the claims. Therefore, all changes that fall within the scope of the claims or their equivalents should be covered by the claims.

This listing of the claims will replace all prior versions of the claims in the application:

1. A base for a child safety seat, wherein the base comprises:
a housing;
a base bracket received in the housing; and
an anchor assembly telescopically and pivotably connected to the base bracket, and at least partially extends out of the housing.

2. The base according to claim 1, wherein the anchor assembly comprises a pivot shaft, and the base bracket is provided with a first sliding groove, wherein the pivot shaft is slidably arranged in the first sliding groove to form a pivot point.

3. The base according to claim 2, wherein the anchor assembly further comprises a connecting part, wherein the connecting part is capable of being anchored to a fixing rod of a seat of a vehicle to form an anchoring point.

4. The base according to claim 3, wherein the anchor assembly further comprises a sliding part, wherein the pivot shaft is located at an end of the sliding part, and the connecting part is fixedly connected to the other end of the sliding part, so that a distance is formed between the pivot point and the anchoring point.

5. The base according to claim 4, wherein the sliding part comprises a reinforcement element fixedly connected to the sliding part.

6. (canceled)

7. The base according to claim 1, wherein the base further comprises:
a limiting press block pivotably connected to the base bracket; and
a reset element connected to the base bracket and the limiting press block to keep applying a reset force to the limiting press block.

8. The base according to claim 7, wherein a limiting groove is formed on the base bracket to limit a pivot angle of the limiting press block.

9. The base according to claim 8, wherein the limiting press block comprises a limiting hole constrained within a range of the limiting groove.

10. The base according to claim 7, wherein the limiting press block comprises a second sliding groove, the anchor assembly comprises a connecting rod, and the base bracket comprises a rotary limiting groove, wherein the connecting rod passes through the second sliding groove and the rotary limiting groove.

11. The base according to claim 10, wherein the limiting press block and the anchor assembly are located at opposite sides of the rotary limiting groove respectively.

12. The base according to claim 7, wherein two limiting press blocks and two anchor assemblies are provided, the base bracket comprises two rotary limiting grooves, and each of the two limiting press blocks comprises one second sliding groove, wherein the two anchor assemblies are connected via a connecting rod, and the connecting rod passes through the two second sliding grooves and the two rotary limiting grooves.

13. The base according to claim 7, wherein two limiting press blocks and two anchor assemblies are provided, the base bracket comprises two rotary limiting grooves, each of the two limiting press block comprises one second sliding groove, and each of the two anchor assemblies comprises one connecting rod, wherein each of connecting rods passes through one of the second sliding grooves and one of the rotary limiting grooves.

14. The base according to claim 10, wherein a direction in which the anchor assembly extends out of the housing is defined as a backward direction, the rotary limiting groove is positioned in a front-back direction, and a size of the rotary limiting groove gradually increases from front to back.

15. The base according to claim 1, wherein the base further comprises a telescopic adjusting assembly, and the anchor assembly comprises a plurality of locking holes, wherein the telescopic adjusting assembly is selectively engaged to one of the locking holes.

16. The base according to claim 15, wherein the telescopic adjusting assembly comprises a telescopic adjusting handle, a linkage arm and a locking pin, wherein the telescopic adjusting handle is connected to the locking pin via the linkage arm, so that movement of the telescopic adjusting handle disengages the locking pin from one of the locking holes.

17. The base according to claim 16, wherein the telescopic adjusting handle is at least partially exposed out of the housing.

18. The base according to claim 16, wherein the linkage arm is formed in an “L” shape.

19. The base according to claim 18, wherein one end of the linkage arm is connected to the locking pin, the other end of the linkage arm is pivotably connected to the telescopic adjusting handle, and the linkage arm is pivotable around a part between the one end and the other end.

20. The base according to claim 16, wherein the telescopic adjusting assembly further comprises a reset element which tends to engage the locking pin with one of the locking holes.

21. The base according to claim 1, wherein the base has two anchor assemblies, wherein a connecting rod is formed between the two anchor assemblies to keep movements of the two anchor assemblies synchronized.

22-83. (canceled)
